(19) United States
(12) Patent Application Publication
(10) Pub. No.: US 2013/0159066 A1
(43) Pub. Date: Jun. 20, 2013

(54) PROGRAMMATIC SALES EXECUTION

(71) Applicant: Michael Wayne Welch, Colorado Springs, CO (US)

(72) Inventor: Michael Wayne Welch, Colorado Springs, CO (US)

(73) Assignee: WELCH GLOBAL CONSULTING, INC., Colorado Springs, CO (US)

(21) Appl. No.: 13/819,257

(22) PCT Filed: Sep. 20, 2011
(86) PCT No.: PCT/US2011/052410

§ 371 Date: Feb. 26, 2013

Related U.S. Application Data
(60) Provisional application No. 61/384,531, filed on Sep. 20, 2010.

(51) Int. Cl. G06Q 30/02; G06T 13/80

(52) U.S. Cl. CPC G06Q 30/0201; G06T 13/80
USPC 705/7.37; 345/473

(57) ABSTRACT

The present invention relates to systems and methods for providing a programmatic approach to guided sales execution. More particularly, the system includes an Executive Engage platform that further includes an impact area model builder, a financial impact model builder, a discovery engine, and an interactive sales process model builder. The impact area model builder is configured for determining at least one impact area for a related group of customers potentially targeted by a sales team promoting a product or service. The financial impact model builder is used for creating a financial impact model for each impact area, wherein the financial impact model shows a beneficial financial impact on the impact area when using the product or service. The discovery engine is configured for creating at least one discovery tool used for collecting information from one of the group of customers to support use of the financial impact models. The interactive sales process model builder is configured for building a business case showing at least one benefit of the product or service to a targeted customer based on the financial impact models created for each of the impact areas.

This application is a continuation-in-part of U.S. Provisional Patent Application Ser. No. 61/384,531 filed Sep. 20, 2010.

### BACKGROUND OF THE INVENTION

1. Field of the Invention

The present invention relates to a process for effecting sales and more specifically to a program for selectively performing tasks to effect the sale of a product or service directed to a particularly technology or industry.

2. The Technology

The success of many commercial enterprises depends on their ability to sell their products, whatever they are. Such products may cover the entire spectrum of commercial activity. The products can fall or be classified in a number of different categories or groups and also in a number of different ways that to some extent relate to the method or means for effecting sales. For example, consumer goods and industrial goods are two broad categories that each have unique and different ways to effect sales. Consumer goods are often sold in retail establishments visited by the consumer. Industrial goods are typically sold to the customer by a sales person/team. As another example, some industrial goods are “big ticket” products and services. The “big ticket” items (i.e., larger price and/or large size) also may be viewed or described as large production equipment and systems. The products and services may range in cost from thousands of dollars to millions of dollars. The kinds and types of “big ticket” items are way too numerous to list. By way of example and not limitation, the “big ticket” items can include industrial spray paint systems, industrial smelter ovens, CT Scan machines, injection molding machines, accounting systems, inventory management systems, packaging machinery, insurance/benefit programs, ore processing equipment, earth moving equipment, bottle filling equipment, municipal water treatment systems, chemical mixing systems, power generating equipment, and the like. In effect, a “big ticket” item is virtually any product, good, service, system or the like, that is normally sold by a salesperson or by a team of sales people and normally not at a sales place like a store or show room where sales staff interact with a customer who may have a team of people acting for or as the buyer.

To effect sales of the “big ticket” items, one may typically expect a sales team from a commercial enterprise to interact directly with a customer. The team may be expected to go through a series of steps or actions to effect a sale. Information must be obtained on the needs of the customer and compared to what the seller has or can supply to meet those needs. While sales of “big ticket” items have been made for many decades, the process of selling has not evolved in any real or significant way. The customer's need is matched to what the seller has to offer or can modify to meet the need. The customer then decides whether or to make the purchase.

Companies spend a lot of money to improve the effectiveness of their sales organizations by investing in sales training, marketing, sales force automation, literature, advertising, client entertainment, and the like. Notwithstanding all the investment to improve sales, most sales organizations struggle to make targets or goals. Many members of the sales teams are assigned quotas, and it is believed that only a small percent of attain and even fewer exceed their quotas.

As part of a marketing program, messages are developed to announce and promote features and benefits of the product. Unfortunately, some of those messages are not grounded in reality. Further, the messages do not focus on the exact needs of the customer. In turn, messages about the product are believed to often be ineffective.

Various kinds and types of sales training camps, sales retreats, sales seminars and other sales training programs are widespread; but their effectiveness is generally believed to be limited. In addition. customer tracking programs and similar electronic tools to automate the collection and sorting of sales information (e.g., leads and contact names and telephone data) are helpful in tracking leads and tracking selling activity. At the same time, these tools do not inform the sales team on what activity or action is needed for this customer that will lead to or is more likely to lead to a sale.

It is also believed that some companies focus on specific sales tools such as specialized spreadsheets and return-on-investment (ROI) calculators. However, these tools focus on assumptions made about the use of the product as envisioned by the seller and not on real use or operations that are likely if the sale is effected. In some cases, it is believed that some tools are so complex, the salesperson is not likely to use the product or use it correctly. As a result, the tool leads to increased cost, but it is believed there is no corresponding increase in sales.

From the above, it can be seen there is a need for methods and programs to organize the sales effort into one that is coordinated and tailored to the product and to a specific customer.

### SUMMARY OF THE INVENTION

A business process and a sales platform are configured for guiding a sales effort. At least one impact area for a customer is identified and targeted by a sales team promoting a product. At least one discovery tool is used for collecting information from the customer and for use to create financial impact models that uniquely convert data to cash flow terms. The data from the discovery and the calculations are presented in real time and may in some cases be manipulated or be deemed interactive in the real time in a presentation.

In some cases, data from multiple sales efforts may be retained in various targeted workspaces for reuse when addressing a new customer.

In most cases, the customer is first qualified. Thereafter the business drivers may be mapped in a system that has an architecture structured to retain the formats but allow data entry to change to create presentations relating to the use of a product for a customer. A model engine is provided in the system to present the financial factors, the business drivers and the impact areas to the customer visually and with an interactive capability. Discovery of appropriate information for the system may also be effected by creating web based interview guides, surveys and data sheets useful in automating the data collection process, which is used to perform an analysis of the customer's needs. Other engines may be used including a real time presentation engine and an animation engine for creating presentations for customers.

In one arrangement, a computer system is assembled with a processor that may be remote and with terminals interconnected to transmit information to and from the processor. A display device may be connected to display information like real time presentations for a customer. The processor is preferably configured with a model engine to prepare models and with a real time presentation engine and an animation engine.

Systems factors to tailor the presentation to the viewpoint of the customer may preferably target known business drivers as well as recognized financial impacts.

### BRIEF DESCRIPTION OF THE DRAWINGS

Exemplary embodiments are illustrated in referenced figures of the drawings which illustrate what is regarded as an illustrative embodiment. It is intended that the embodiments and figures disclosed herein are to be considered illustrative rather than limiting.

FIG. 1 is an illustration of the major milestones in a sales program involving consultations with the customer;

FIG. 2 is an illustration of a business driver mapping process to address one or more business drivers and the financial impacts in accordance with one embodiment of the present invention;

FIG. 3 is a flow diagram of process of business driver mapping of FIG. 2;

FIG. 4 is a depiction of the architecture of the entire system in using graphical or functional factors;

FIG. 5 is a depiction of a user interface screen that a user would see and use to interface with a computer executing or using the system;

FIG. 6 is a depiction of the architecture of a model engine used to compute in and present data.

FIG. 7 is a flow chart showing the flow of data in a model engine;

FIG. 8 is a graph of a model engine presenting data of theoretical example involving a telephone sales system;

FIG. 9 is an image of a data input page visible on a users computer for a theoretical example involving a telephone call system;

FIG. 10 is a chart showing theoretical model interface calculations for a theoretical example involving a telephone call system;

FIG. 11 is an image depicting a system administration data input page for creating and editing close rate for a theoretical model interface calculations for a theoretical example involving a telephone call system;

FIG. 12 is a graph of a cash flow model of a theoretical example involving a telephone sales system involving the close rate of sales made by telephone;

FIG. 13 is an image of a data input page for the cash flow model used to select financial models that are summarized in the cash flow model;

FIG. 14 is an image of a business case model visible on a users computer for a theoretical example involving a telephone call system;

FIG. 15 is an image of the data input page of the business case model used to select cash flow models used in the business case model of FIG. 14;

FIG. 16 is an illustration of a real time presentation for selling a theoretical telephone call system;

FIG. 17 is an illustration of the logic flow for preparing and presenting a real time presentation;

FIG. 18 is a flow diagram for the creation of an animation of the animation engine of the present system;

FIG. 19 is an illustration of an administrative interface for use with an animation engine for a theoretical smart phone;

FIG. 20 is an illustration of the intelligent asset that is used in the animation engine in use for a theoretical smart phone;

FIG. 21 is an illustration of a screen seen in the operation of an animation engine;

FIG. 22 is an illustration of a library screen seen in the operation of an animation engine for animating a theoretical smart phone;

FIG. 23 is an illustration of an actions screen seen in the operation of an animation engine for animating a theoretical smart phone;

FIG. 24 is an illustration of an actions panel seen in the operation of an animation engine for animating a theoretical smart phone;

FIG. 25 is a sample task list used for conducting discovery;

FIG. 26 is a sample stakeholders profile prepared as part of the discovery process;

FIG. 27 is an illustration of a list of resources provided by the sales team to help with a sales execution project directed at the targeted customer;

FIG. 28 is an illustration of a sample interview guide for use in the discovery process;

FIG. 29 is an illustration of an interview guide that has been customized to a targeted customer for use in the discovery process.

FIG. 30 is an illustration of a sample data sheet for use in the discovery process; and

FIG. 31 is an illustration of a survey for use in the discovery process.

### DETAILED DESCRIPTION OF THE PREFERRED EMBODIMENTS

Reference will now be made in more detail to the illustrated embodiments of the present invention, systems and methods for a programmatic approach to sales execution. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention.

Accordingly, embodiments of the present invention provide for a programmatic approach to guided sales execution based on business drivers, such that product or service benefits are organized around business drivers and not necessarily technological advances.

### Notation and Nomenclature

Embodiments of the present invention can be implemented on a software program for processing data through a computer system. The computer system can be a personal computer, notebook computer, server computer, mainframe, networked computer (e.g., router), handheld computer, personal digital assistant, workstation, and the like. Other embodiments may be implemented through specialized hardware for purposes of implementing a programmatic approach to sales execution. This program or its corresponding hardware implementation is operable for enabling the integration of one or more applications supporting the completion or implementation of a work flow or process.

In one embodiment, the computer system includes a processor coupled to a bus and memory storage coupled to the bus. The memory storage can be volatile or non-volatile and can include removable storage media. The computer can also include a display provision for data input and output. In other and more typical applications, multiple computers are interconnected to, by and to form a network to provide for communication of data between computers and in turn to effect communication between users to allow for input from different users and out put to different users.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

The term “products” is used herein to refer to anything that one can sell including services, software, financial products, machines, vehicles and insurance. The term “big ticket” typically refers to something that has large value in proportion to the business. Thus a $3000 All Terrain Vehicle (ATV) would be a relatively minor purchase for very large corporation (sales revenues in excess of $1 billion) and a huge purchase for a very small company (sales revenues under $100K. The considerations in making the decision to buy could be quite similar, but staffing and management involvement could be quite different. Of course “big ticket” typically means and includes purchases of products the value of which can extend from perhaps around $100,000 USD to well above $10 million USD (e.g., a large jet airplane); but at the same time, it can also mean a relatively modest purchase involving a few thousand dollars which is sold for use in the production of income or other value.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining,” “creating,” “storing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Further, throughout the Application, the term “database” may be used to describe a location for storing information or data, and/or a mechanism for storing information or data. As such, “database” is interchangeable with the storage, data store and similar terms.

### Decision Information

Sales efforts to sell “big ticket” products prior hereto have typically included or focused on the “return-on-investment” (“ROI”) to the customer. That is, the value or cost to purchase the “big ticket” product or service would be compared to a financial model involving its use and the benefit obtained as a result of the purchase and use of the “big-ticket” product such as, for example, reduced labor cost, increased production; lower use of raw materials, and/or other comparable factors which can be quantified to show a financial benefit to be realized by the customer. While ROI was and still is certainly a factor of import to some if not many customers, it has been determined and is heretofore not been appreciated by sales personnel and sales teams that the focus must be shifted to both a total financial analysis coupled with a showing on how the “big ticket” product supports the business drivers of the customer. That is, the inventor has discovered that nearly every company will focus or look at the connection of the “big ticket” product to its business drivers that include growing revenue, controlling (e.g., lowering) costs, retaining customers and increasing work force productivity.

As to the financial factors, the purchaser today looks for a lot more than ROI and is now looking at a total a financial analysis that involves the following factors: the amount of the investment; the cash flow generated by the “big ticket” product; the net present value (NPV) created by making the investment; the total return by making the investment; the payback period; risk factors (e.g., a long pay back period increases the risk of market change that could have a negative impact on the expected financial rewards projected at the outset; and an elasticity analysis (i.e., how changing an economic variable affects other variables).

### Milestones

To proceed in a way to address the business drivers and to complete an analysis of the financial factors, one must proceed in a particular way to ensure that the analysis should be undertaken and if so how to collect the information needed to complete the analysis.

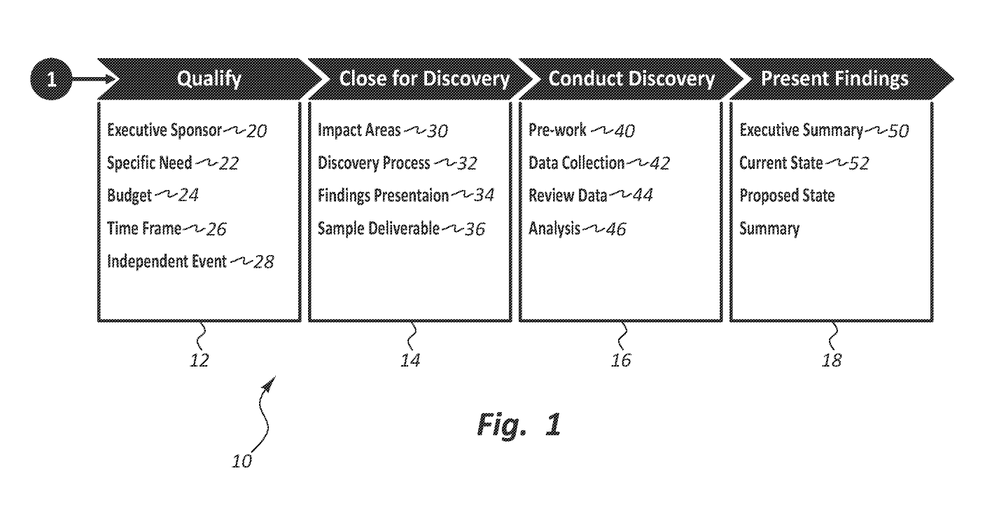

Embodiments of the present invention provide for a web based interactive process model to define the sales process. That is, a user obtains firmware including a computer configured with programs and such other accessories so the user is able to connect to the world wide web (WWW) and to thereupon connect to a source accessible through the web to obtain a program that takes the user through specific steps or processes to complete the desired analysis. Alternately, one may obtain a computer or computer system with one or more stations or terminals and with access to programs and other accessories through or using the world wide web. Alternately, one may have a disc or flash drive that contains the desired program(s). FIG. 1 is an illustration of a customized and interactive process or program 10 used to organize the sales process. As shown, one first must connect to the web using a suitable computer and then access the program as illustrated in bubble 1. As shown, when the process or program loads into the user's computer, the screen shows the user a model that expands to the right revealing the four basic milestones numbered 2 through 5 in the sales process.

As seen in FIG. 1, the first step is to qualify the customer or the lead 12 to determine if its even worth the time and effort to attempt to sell a “big ticket” item to a particular customer. Thereafter one must close for discovery 14, conduct discovery 16 (bubble 4), and present findings. Each of these steps involves a number of elements that are seen here in a drop down box all as more specifically set forth hereinafter.

Qualification 12 is a very important step. A sales executive must first be identified 20 as the customer who supports the sales effort. The executive broadly looks at the “big ticket” product in correlation to the business of the customer to determine if there could be or is a specific need 22. If “no” or “not,” the sales lead is disqualified and the matter is closed. If “yes,” the sales executive 20 will provide enough information so the sale team may thereafter develop a budget 24 (e.g., travel to the customer's offices, testing, cost to conduct other discovery for effecting the sale as well as setting out a time frame 26 for completing a sales effort. Typically one will also look for an impending event 28 that would allow the benefits of the “big ticket” product to be demonstrated or confirmed.

To close for discovery 14, one secures approval from the executive 20 of the customer to proceed with discovery because the lead or customer has been initially qualified. The impact areas 30 for the “big ticket” products need to be carefully evaluated along with the selection of a suitable discovery process 32 and then the selection of a suitable or desired form or type of findings presentation 34 (discussed subsequently). Also a determination is made if and how and when a sample could be delivered 36 to the customer or other steps taken to demonstrate the “big ticket” product.

To conduct discovery 16, a sales team will setup the project (pre-work) 40, contact the customer to collect data 42 with the support of the executive 20 including going on site to observe operations. Thereafter, the sales team will review and analyze the data 44 and 46 and then assemble it or process it into the findings presentation.

The sales effort is completed by presenting the findings 18 to the sales executive 20 in the form of an executive summary 50 (detailing the overall impact), outlining the current state (how things are done today) 52, providing a proposed state (recommendations to improve the business) 54 with a focus on the business drivers. And finally, a financial summary is presented reviewing the financial factors and in turn the benefits of the “big ticket” product.

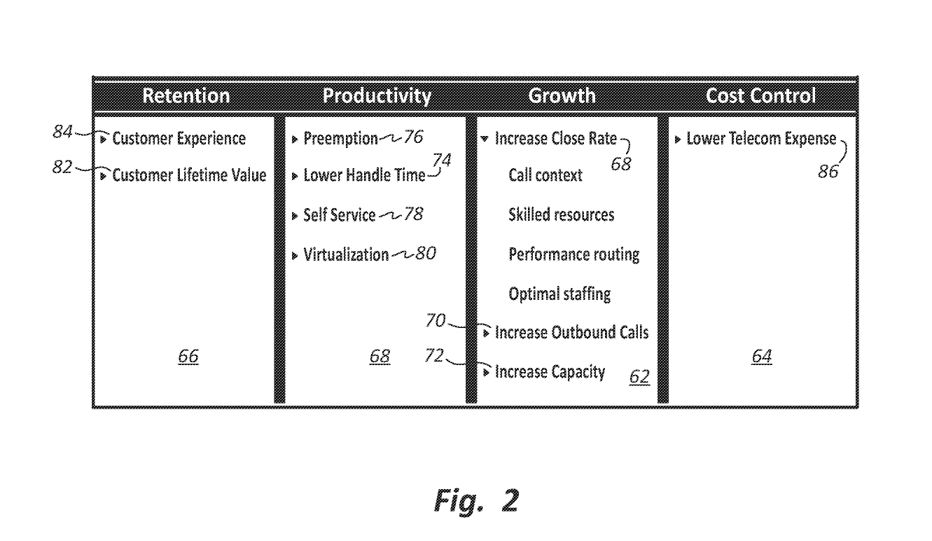

To take the user(s) through the steps 2-5 of FIG. 1, a computer system configured with a suitable software program or with access to a suitable program has been devised to crate a visual guide for the user (e.g., the sales team) and to help the user to execute each step. The program centers on 6 separate and distinct functions. Business Driver Mapping (see FIG. 2) links solution benefits to each of the business drivers 62, 64, 66 and 68 and financial impacts. Platform architecture is provided that is used to create interactive financial model so that the financial model remains current as new data becomes available. It is also used to create discovery tools and a real time presentation. A novel model engine is created to show individual solution benefits as a single function impact model in cash flow terms. Alternately the engine can present data in other forms by identifying and calculating key metrics and then presenting them in an interactive manner. Thus business cases can be developed in real time. A real time presentation engine has been created to present interactive presentations that include a variety of data functions/streams including real time financial models, streaming video illustrations, data driven animations, and real time data base connections. An animation engine is also provided to allow the team to present live interactive animations which link to business drivers and the financial impacts. Finally, there a collection of tools are assembled for automated discovery and allow for automated gathering of data to complete the discovery process.

Business Driver Mapping

Business driver mapping is better illustrated in FIG. 2. It is a process that takes data and organizes it around each of the business drivers 62, 64, 66 and 68. Thus, in FIG. 2, we see a window or chart 60 that will appear on the screen of the computer of a user. The chart 60 presents 4 tables, one for each of the four business drivers, namely: growth 62, cost control 64, retention 66, and productivity 68. Each of the business drivers illustrated includes a number of impact areas. Each time a user encounters a new “big ticket” product and/or confronts a new customer, a new business driver mapping screen is prepared. Thus in FIG. 2, under growth 62, we see, for a “big ticket” product that is a theoretical telephone call processing system, purchase and installation of that system leads to three noted impact areas which are: increase close rate for calls 68, increase in capacity 72, and increase in the quantity of outbound calls 70. The increase in close rate 68 does not necessarily mean that the close rate in fact is increased, but the increase in close rate can be the result of changing or increasing the chances of closing a sale by the customer. To do that, the theoretical call processing system provides the buyer with a “screen pop” which is an image seen on the computer screen of the user that contains call context information such as the identity of a particular promotion about which an outside customer is calling, special offers, pricing and other related data. While not forcing a sale, it helps increase the close rate.

In a similar fashion, the productivity 68 business driver shows that the telephone call processing system will lead to lower handling time 74, preempt 76 other activity by sales personnel or operators that reduces productivity, provide operators with self service 78 and in turn lead to virtualization 80 for some due to included automated calling. The retention 66 driver shows that the buyer or customer acquiring the theoretical call processing system will want to keep it because it presents a long term value 82 and will be a good experience 84. In turn, the cost control 64 driver shows that purchase of the “big ticket” telephone call processing system leads to lower overall cost 86. It may be noted that in FIG. 2, that the illustration can be configured by the sales team so that the team will collect information about the drivers for a particular “big ticket” product and more particularly about each impact area selected or arising under each of the drivers. Thus the user could click on a selected impact area such as “increase sales rate” and get a pull-down below the table that explains the elements of that impact area that have been selected by the user.

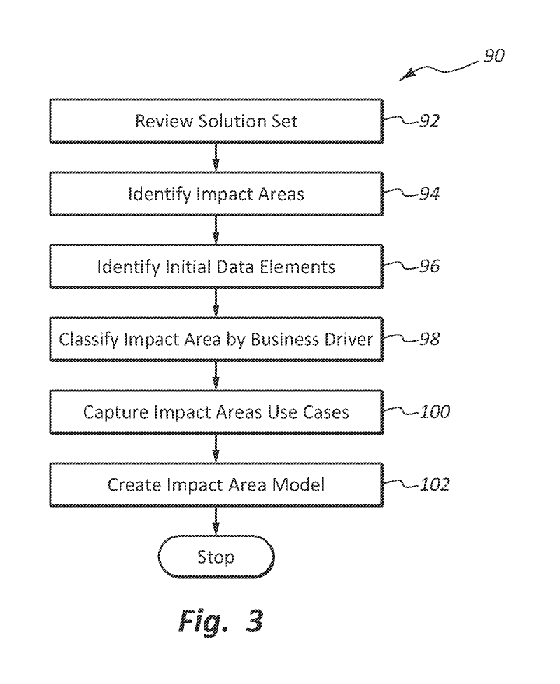

Turning now to FIG. 3, we see a flow chart 90 that illustrates the steps in mapping the business drivers 62, 64, 66 and 70 seen in FIG. 2. That is, the mapping of FIG. 3 requires one to review the solution set 92 by establishing or selecting the identity of what “big ticket” products are being sold. Once identified in the context of a prospective customer, the impact areas can be identified 94 and sorted into the applicable business drivers 62, 64, 66, and 68. Of course, discovery 16 will develop or assemble data elements 96 that are directed to the impact areas of each driver 98. The impact area data is next converted to a case specific example 100 which of course leads logically to the development of a strategy to effect the sale 102. Business driver mapping is critical because it forces the user to identify the impact areas for each driver and to select and evaluate that selection in the terms of the product which the user wants to propose to a customer.

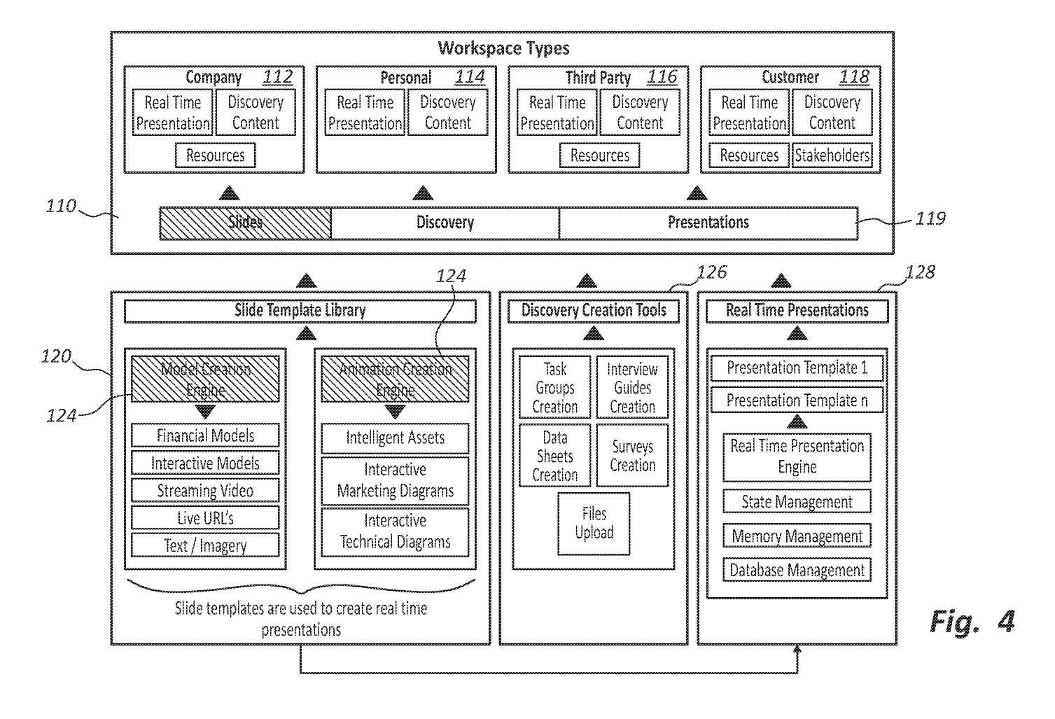

The platform architecture is seen in FIG. 4. A unique system of workspaces 110 is provided each of which is in effect a file or series of files in the memory of a computer accessible when desired. Each of the workspaces 110 allows users to complete and retain work and reuse it for multiple applications. Thus, the user can retain real time presentations, interview guides used to interview a stakeholder, data sheets, surveys and other related data because sales of the same products to different customers will typically involve very similar drivers. Thus one is able to save work from prior sales effort and reuse it for selling the same product to a different customer or selling similar or even different products because much of the data required is similar. As herein illustrated, the workspace types include a company workspace 112 useful for retaining materials that are useful for any and all members of a sales team. The personal workspace 114 is useful for retaining information unique to each person who is working to promote sales and may be part of the user or sales team. The third party workspace 116 is for retaining information supplied by third party companies or as otherwise assigned. And the customer workspace 118 is for storing discovery information germane to a particular customer. Thus the members of a sales team may access all needed information, fill in or supply, correct and update and assemble information for effecting, for example, driver mapping (FIG. 3). The workspace system includes sub files or sub directories for real time presentations, discovery content and other resources as indicted. A tool bar 119 allows the user to access libraries of different presentations to select desired materials for transfer into one of the workspaces 112, 114, 116 and 118.

In FIG. 4, we also see a slide template library 120 which can be accessed from any work space. The library 120 includes an inventory of slides used for creating real time presentations. The slides in the library are created using the model engine 122 or an animation using an animation engine 124. As seen in FIG. 4, the slide template library 120 includes whatever types of slides that have been or could be created as indicated. Similarly the animation creation engine 124 also may access, for example intelligent assets and other diagrams as seen in FIG. 4. The architecture of the system also has been structured to include discovery creation tools 126 that are useful to collect data for use in future sales efforts. The various tools are identified in FIG. 4 and logically include, for example, surveys, interview guides, data sheets all as seen in FIG. 4. Also seen are real time presentation tools 128 useful to create real time presentations for use, for example, when presenting findings 18.

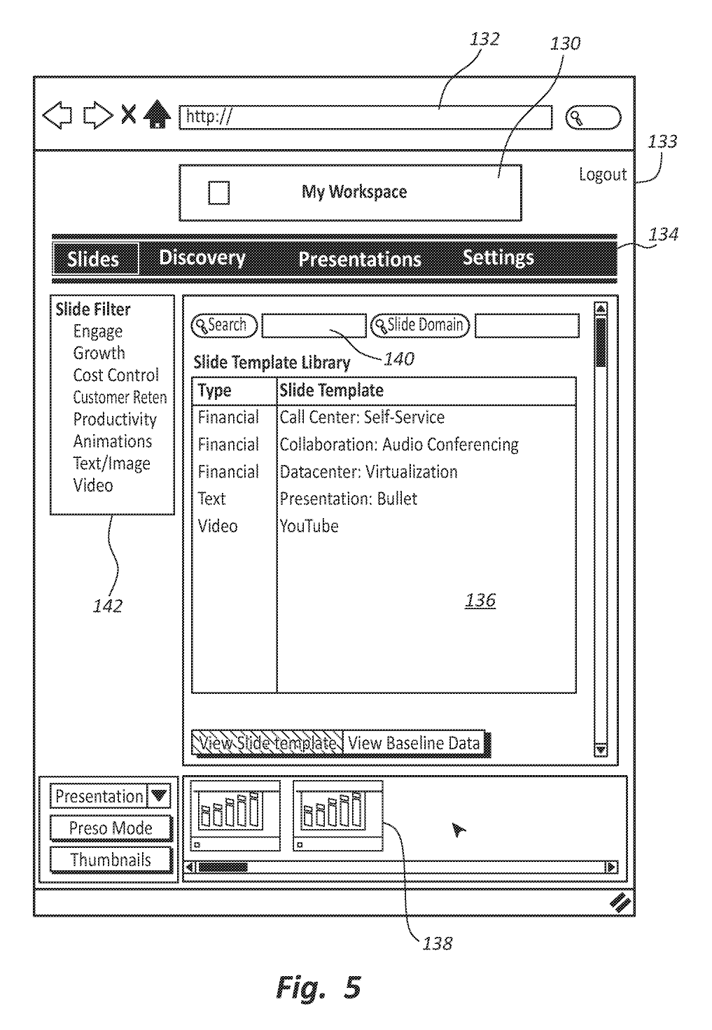

To interface with the various workspaces 112, 114, 116, and 118 in the computer system of the user configured to operate as herein disclosed, a user will call up and access the screen 130 a sample or example of which is illustrated as FIG. 5. The workspaces 112, 114, 116, and 118 are accessed by first accessing a remote server or main frame over the internet using suitable routing data that is entered into a search bar 132. Once accessed, the screen 130 will fill with data that has been collected or assembled for a particular presentation. With the screen 130 filled with applicable data, the user may access a desired workspace of FIG. 5 by selecting one using the screen button 133. The user may also use a search or navigation bar 134 to access categories of information as named in the bar. A library 136 of slide templates is identified so the user can access whatever template is desired. A current or active slide inventory for a current presentation 138 is present to allow the user to access any desired slide. The screen 130 also shows the availability of tools 140 to search for specific and desired slides as well as a filter 142 to sort slides by particular type. Tools 136 are also provided to deal with slides within a particular workspace.

Turning now to the model engine earlier identified, it uniquely has been created to replace and avoid use of a common tool used to present data referred to as a “spreadsheet.” Each spreadsheet is typically designed for each specific use to present data in a tabular or columnar form to show relationships. For business drivers, the impact areas will vary from customer to customer and from product to product so that a standard spreadsheet is not available. Only skilled users and operators are able to assemble or put together complex spreadsheets with complicated relationships. The model engine that is incorporated into the illustrated and disclosed system uniquely presents and processes data that shows cash flows for each impact area, supports virtually an unlimited series of models, and creates a “snap together” system that allows financial models to be assembled much like building blocks. Further, the model engine incorporates functions that allow the system to reflect changes in cash flow in real time.

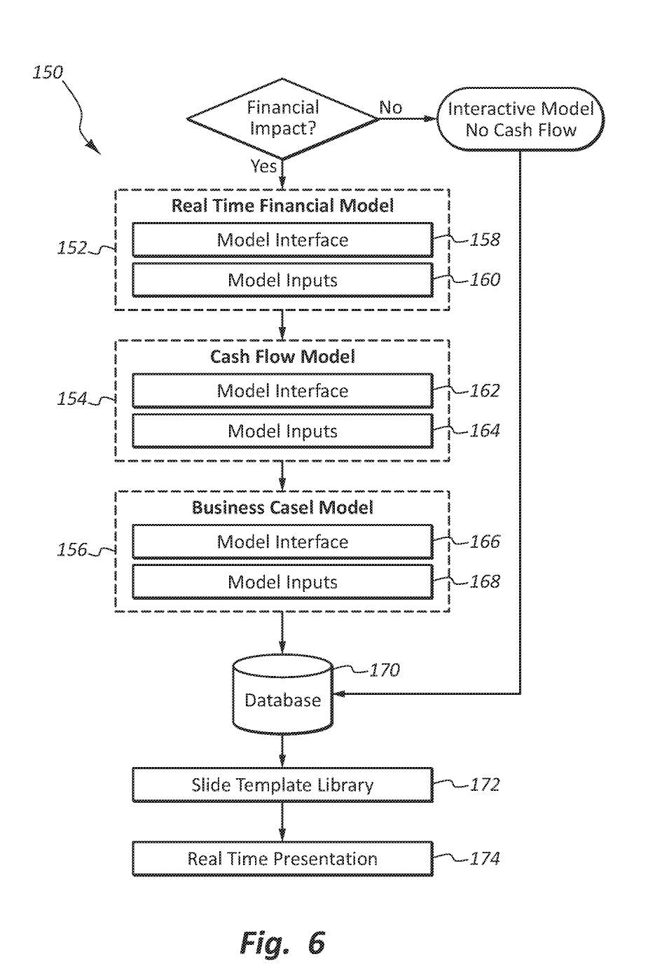

FIG. 6 depicts the architecture 150 of the model engine which develops a real time financial model 152, a cash flow model 154 and a business case model 156. Initially, the user will need to select between a process in which there is a financial impact 161 and one where there is no financial impact 163. That is, the product could be one in which the financial impact is not involved. When it is, the real time financial model 152 includes a model interface 158 that allows the user to manipulate data in real time during a presentation. Thus the user may add, subtract, include and exclude as desired to suggest different results for different data and to present different or corrected results as data changes. Of course the system would necessarily need to have an input function 160 to accept data in whatever form and convert it for use in effecting the desired calculations for the real time financial model.

The cash flow model 154 has a model interface 162 and model input function comparable to the real time financial model. The cash flow model senses or reads changes in financial models in the real time presentation. Any changes in the financial models are reflected in real time in the cash flow model. The business case model 156 senses or reads changes in cash flow emanating from the cash flow model 154, which are then reflected in the business case model in real time. The business case model 156 also has a model interface 166 and a model input 168.

The real time model 152, the cash flow model 154 and the business case model 156 each are connected to a database 170 typically in parallel so that each model may directly access the data used by them. Each can be connected or disconnected by any suitable means (e.g., a key stroke) that allows the user to add or subtract models at will and in effect snap them in and out of the system so they are like or can be visualized to be comparable to building blocks.

The model engine also includes a slide template library 172 which houses all the various models of slides used in the system. Users can call up the models (in, for example, the user's workspace; see FIG. 5 and the disclosure relating thereto) using drag and drop technology. Thus, a slide template can be dragged and dropped in a real time presentation 174. The real time presentation is connected to collect and present financial models in real time with data being updated in real time. It may receive live streaming video, live URL's and data from external data bases.

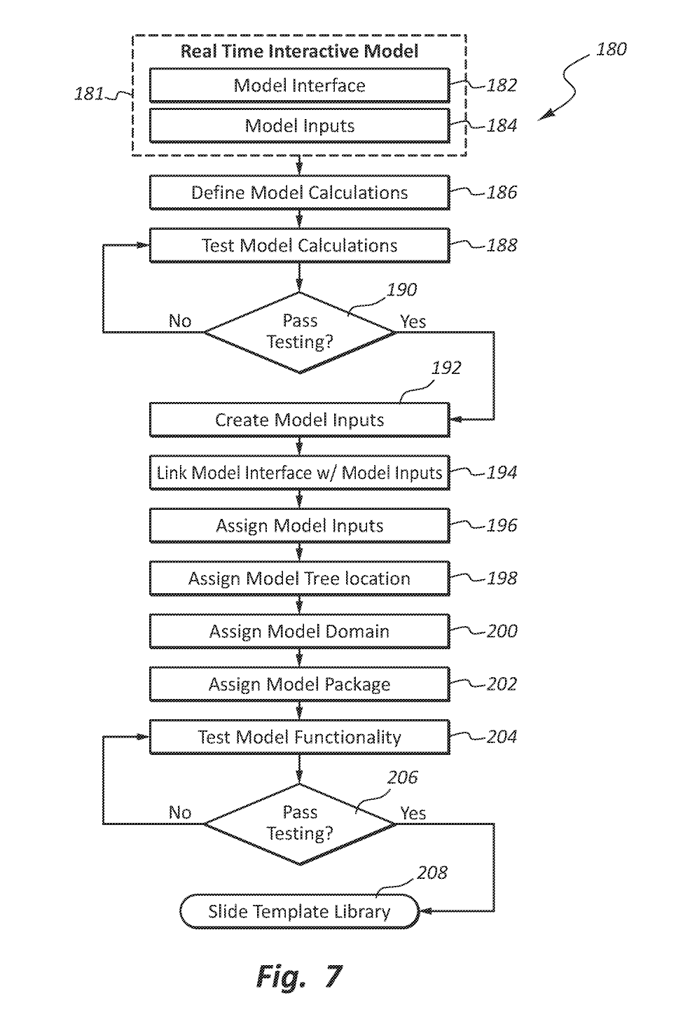

Turning now to FIG. 7, a flow chart shows how the model engine works within the overall system. FIG. 7 shows the steps taken by a developer of a model for a particular customer and/or product. The same steps will be taken for each model desired. Once the model is loaded into the library, it can be called up and used as a template for the user to insert data. The model is configured to conduct calculations automatically to present desired results in static or real time. The flow chart 180 shows as an example, development of the real time interactive presentation 181 which is like or comparable to the real time presentation 174 (FIG. 6) with a model interface 182 to receive data from the user, some well known charting applications, or other suitable sources. The model inputs 184 are connected to an underlying data base like data base 170.

The real time interactive model 180 supplies data to a mathematical processing step 186. The model calculations have been developed and preloaded to calculate specific data like total sales or total units as discussed hereinafter. Once the model calculations are developed, the model developer tests the model calculations 188 to make sure it is presenting financial data and key metrics in real time and to update with changing data. The developer may test in different ways to make sure that the calculations that are preloaded into the model or slide are correct. For example the developer of the model may create a graph or chart to see if the data fits an expected result. If the test calculation 190 are satisfactory, then the model is next configured to accept model inputs 192.

For each interactive model, the model inputs 192 are linked to a model interface 194 that is much like model interface 182. The data is then assigned 196 to a model type such as the model it supports. Such a model may be a financial model, an animation model, and the like. If the data is sensed to be financial, then the model being developed will be configured so that the financial data will be accessible to other financial models and will appear in a tree 198 or location which in effect determines where it will appear within the system for access and use by users preparing a sales presentation 18 for a customer. A model domain 200 has been created and is used to filter the data so that it will match or fit a template when the user is looking for or selecting a desired template. Thereafter, the various models that have been created are configured so they can be assigned to a client account 202 for access and use in connection with that account and the related presentation of findings 18 (FIG. 1) when filled in. Data may be presented in a test model 204 to determine if it is logical or fits within guidelines. If the model passes testing 206, the model created is sent to storage as a template in a slide library 208. If it does not, it is sent back for redesign or correction until it meets or performs as desired.

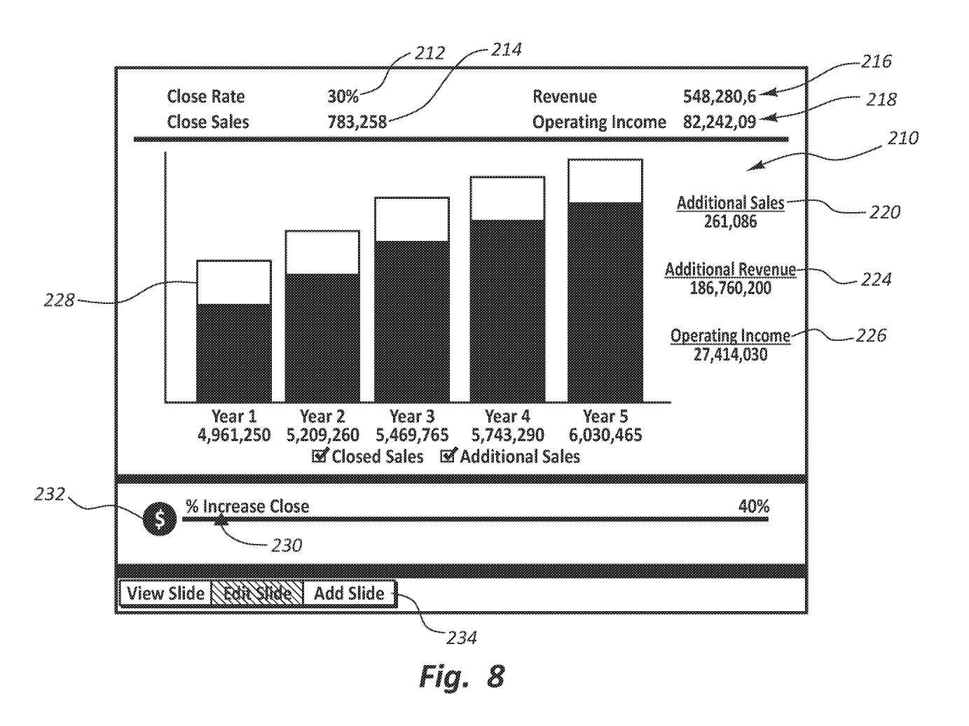

To better understand how the model engine discussed herein above operates, let us assume that a proposal is made for a telephone call processing center similar to that discussed hereinbefore. The close rate comparable to close rate 68 is an impact area for the growth business driver 62 (see FIG. 2). Operation of the system will produce a graph as seen in FIG. 8 showing an increase in close rate visually depicting the increase in cash flow 228 from the increasing close rate. The numbers shown are purely hypothetical and do not reflect any known business or system. The close rate impact area 210 of FIG. 8 is depicted as a model that is created using a suitable template and migrating and integrating data from the data base into it. Various calculations are preset to process and calculate various numbers including, for example, the close rate 212, close sales in units or calls, 214, close revenues in dollars 216, and operating income 218. The model is set to automatically calculate the additional sales 220 in units or calls, the additional revenue in dollars 224 and the total operating income 226 in dollars. To show differing metrics, a slider 230 is available for use to, for example, vary the close rate. Alternately one can toggle switch 232 to separate data input boxes to vary the data and the results. A tool bar 234 is provided to allow the user to input data used in the calculations and provide other slide options.

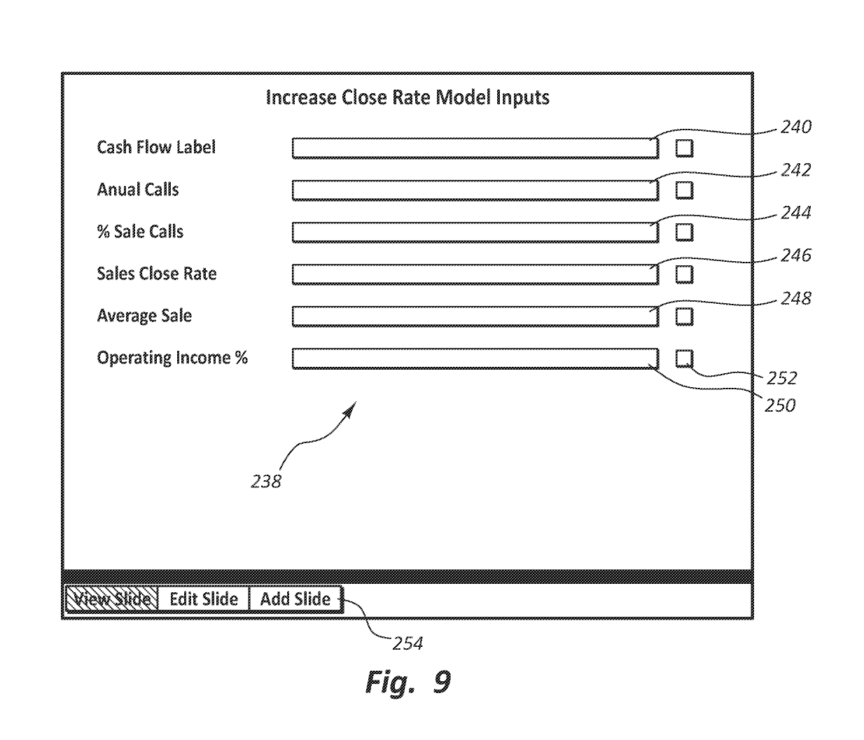

Data input boxes 238 that are presented when one selects “edit slide” in the tool bar 234 are shown in FIG. 9 for the telephone call processing system discussed as an example. An input is provided to label the source of cash flow 240. Also provided are boxes tailored to this example to show total annual calls 242, percent of calls that are sales calls 244, close rate 246, average sale 248 and operating income 250. A separate field 250 is provided to allow a user to add notes like to identify the source of data. The user is able to vary the data as desired to show alternate results in FIG. 9. A tool bar 254 is provided to allow the user to edit the data but not the slide function itself.

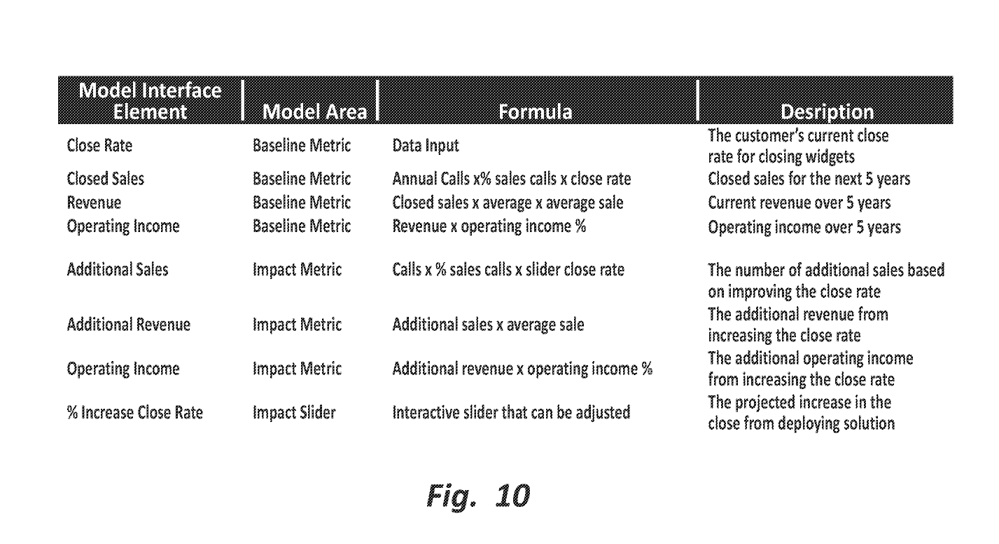

In furtherance of the example involving a telephone call processing system as hereinbefore presented, FIG. 10 shows the type of calculations that are undertaken to create the data that is presented. It should be noted that the data created for most blocks showing numbers for the future are projections based on past history and may increase as well as decrease.

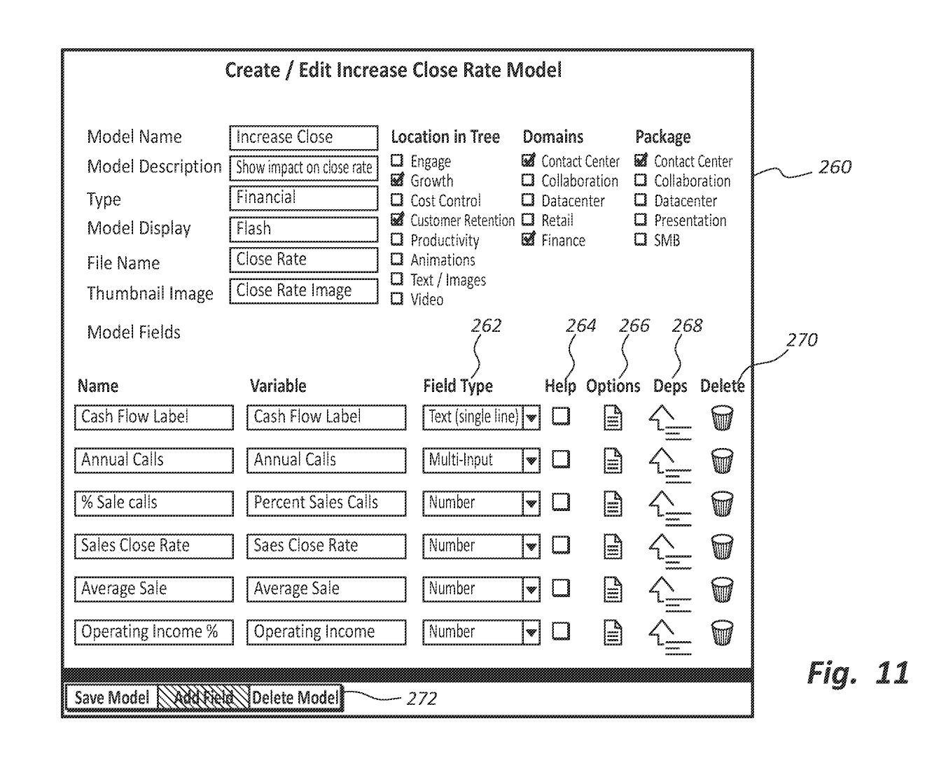

FIG. 11 is a system administration input screen used by the model creator 260 presented on a computer. That is, the present system has a computer configured to present a screen image with data fields to receive input data from the model creator which connections the model interface with the model inputs and places the model in the slide template library. The data fields are labeled and are mostly self evident for the telephone call processing system of the example. Other products would be configured to receive other data pertinent to that product. The data input fields for each model are fixed and to be of different types based upon the specifications of the model. In FIG. 11, the fields of data include a field type 262 which allows the model creator to input the type of variable field needed for the data. A “help” field 264 is provided to allow the user to access explanatory assistance and make the system user friendly. An “options” field 266 is a drop down list of options available to manipulate the data. A “dependents” field 268 is a field that is dependent when the edit slide 230 (FIG. 8) is selected and operated. The delete icon 270 allows the model creator to delete an entire field from the involved data base. A tool bar 272 is also available to the model creator to save, delete the model and add fields if they are available for this model.

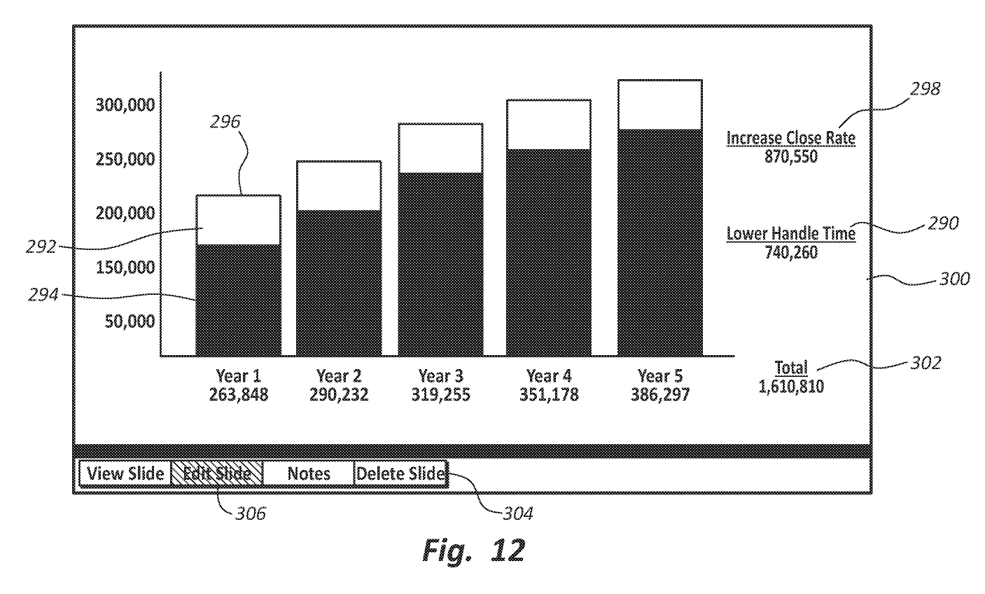

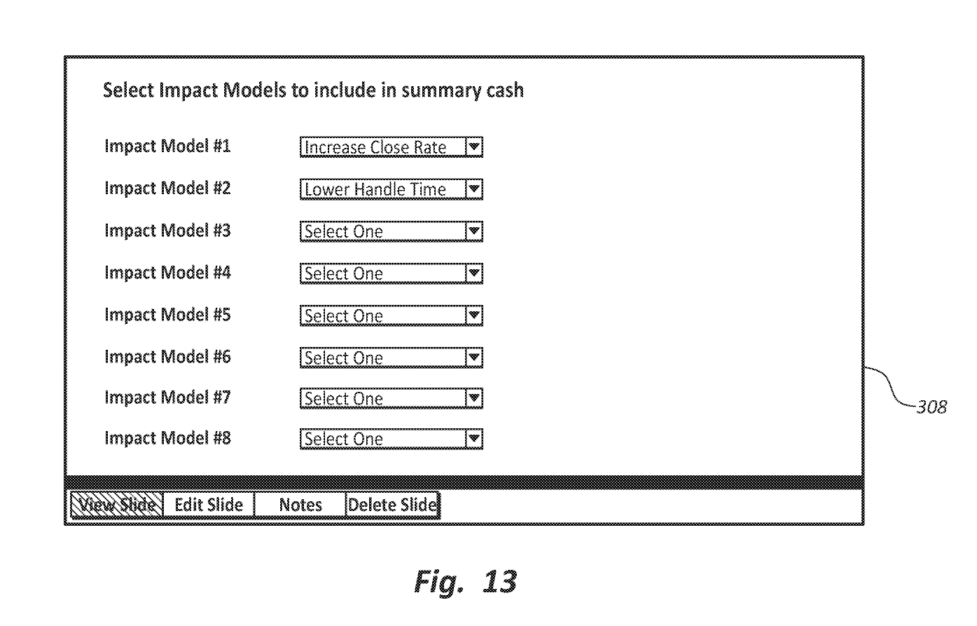

As earlier stated, the model engine translates each impact area into a single function that expresses benefits in terms of cash flow. Thus, a change in the rate of closing sales or shortening the time to complete a sale can translate into cash flow. FIG. 12 shows a cash flow model 290 that summarizes the cash flows from the Increase Close Rate financial impact model 292 and a lower handling time financial impact model 294 into one bar 296 for the example that involves a telephone call system. The total 302 is the total cash flow that was generated from the Increase Close Rate and Lower handle time financial models for the entire period is also shown. The total 302 is the total cash flow that was generated from the Increase Close Rate and Lower handle time financial models for the entire period is also shown. A tool bar 304 is provided that allows operations as seen. The edit slide button 306 when depressed causes a screen 308 to appear on the user's computer a sample of which for a telephone call system example as seen in FIG. 13. In effect, it allows the user to select the impact area models to be summarized in the cash flow model 290. The financial models are selected from the drop down list, and each financial model is added to the list as it is created.

To shorten the sales cycle for a “big ticket” product and in effect complete the sale faster, a credible business case must be presented. As earlier mentioned the financial factors of a good business case include the amount of the investment; the cash flow generated by the “big ticket” product; the net present value (NPV) created by making the investment; the total return by making the investment; the payback period; risk factors (e.g., a long pay back period increases the risk of market change that could have a negative impact on the expected financial rewards projected at the outset; and an elasticity analysis. The role of the business case model is to capture the cash flows from the various cash flow models (for that presentation). A presentation may have multiple cash flow models that are used to summarize and visualize the business drivers for different areas of the customer's business. The business case model may roll up the different cash flow models to form the business case. Additionally, one presentation can include multiple business case models.

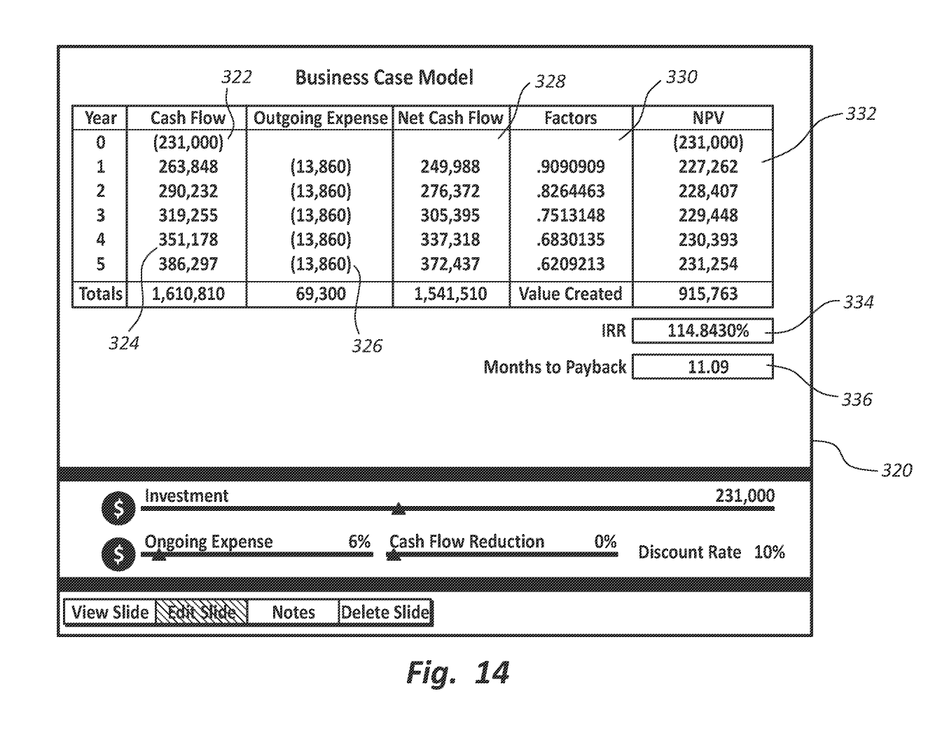

FIG. 14 is a business case model 320 for the theoretical telephone call processing system being discussed as an example. It shows the initial investment 322 along with the cash flow being developed 324. Ongoing expenses are seen 326 that are subtracted to create a net cash flow 326. The net present value (NPV) given the time period is calculated as follows:

$$NPV = \sum \frac{{CF}_{t}}{{( 1 + r )}^{t}}$$

Where CF means cash flow
   t means time from t₀ to t₁
      (4 years in example)
   r means the discount rate

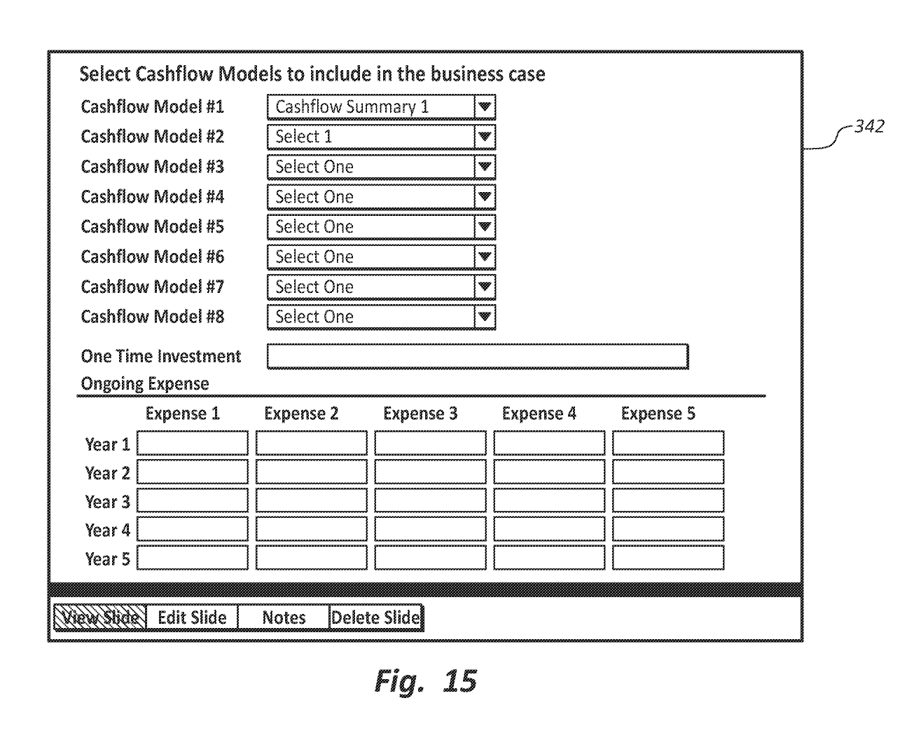

The NPV is applied to the Net Cash Flow 328 to yield the NPV of the cash flow, which translates cash flow received in the future into today's dollars. A calculation is also made to show the internal rate of return (IRR) 334 and the number of months for payback 334 which is the time it takes to recover the investment 322. The business case model of FIG. 14 also has a tool bar 338 which has a button to allow the user to effect certain actions. The edit button 340 causes a screen 342 (FIG. 15) to be presented on the user's computer to allow the user to select the cash flow models to include in the business case and input data such as the investment and/or ongoing expenses being observed in the business case model 320.

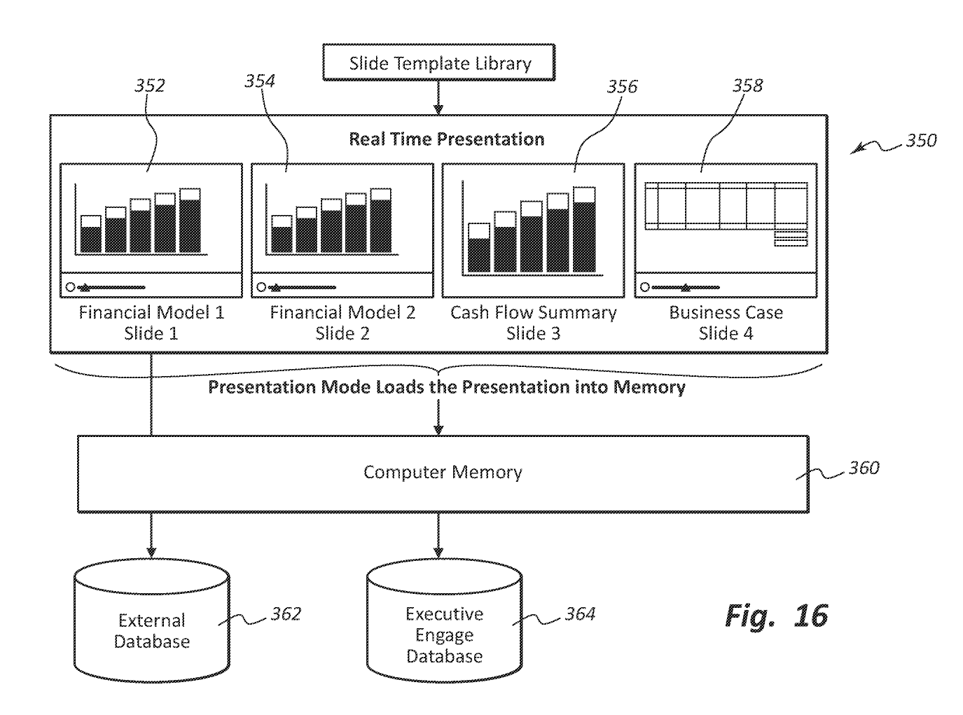

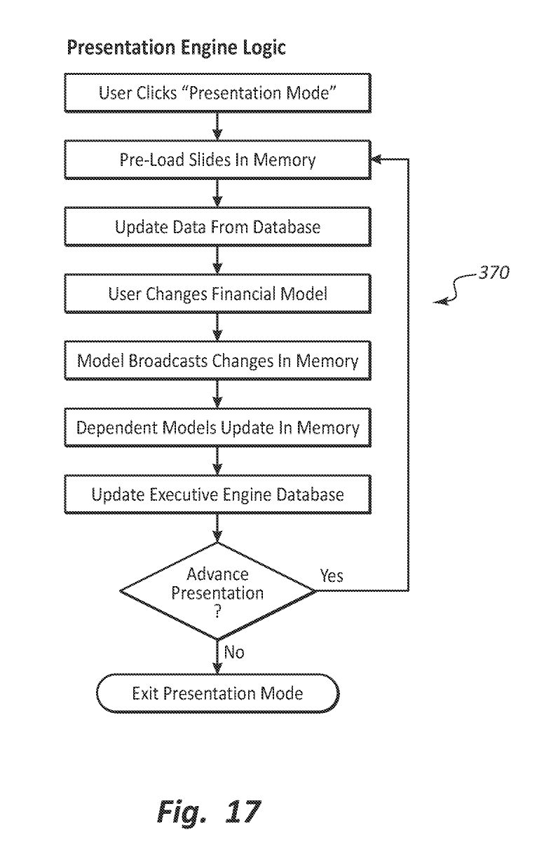

As noted in connection with FIG. 1, the presentation of information 18 is the step that is necessary to complete the sales process for the “big ticket” product or for any product or service that is being presented to business for purchase. A real time presentation engine has been created to present the information from the various models visually. FIG. 16 is a sample real time presentation 350 for the telephone call system example that has been used herein to illustrate the overall system operation. Notably, the real time presentation includes multiple screens or images that include financial models 352 and 354, cash flow model 356 and a business case 358. Obviously, the real time presentation can include other models, images and summaries as desired by the user. The data is all accessible from the computer memory 360 and also from external databases 362 and 364 that may be needed for selected data. FIG. 17 is a simple flow diagram 370 showing the steps for the real time presentation engine. The steps are labeled and in turn self-explanatory.

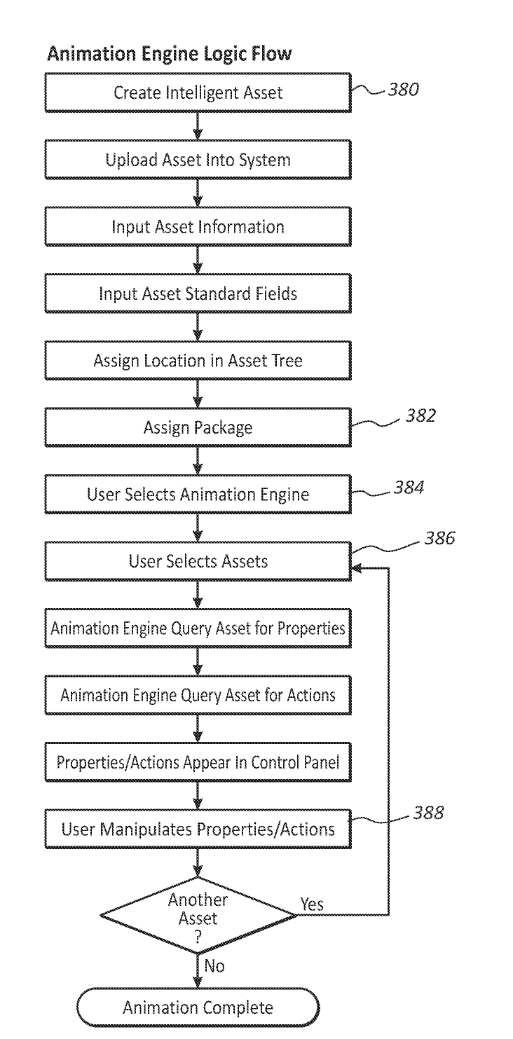

As an improvement and additional feature, the real time presentation can include animation that is generated by an animation engine in the computer system. FIG. 18 is a flow chart showing the logic of the animation engine. The steps are explained in FIG. 18. As can be seen, assets are created 380 using external tools which can include Adobe Flash, HTML, and other imaging systems. These assets are uploaded into the computer system and assigned to a specific sales program or presentation 382.

When the user goes to create an animation, the asset will appear in the asset browser in the location specified by the developer. The user can include the asset in the animation and access the functionality of the asset, e.g., make a call. The user cannot change an asset, they can only access inherent functionally created by the developers.

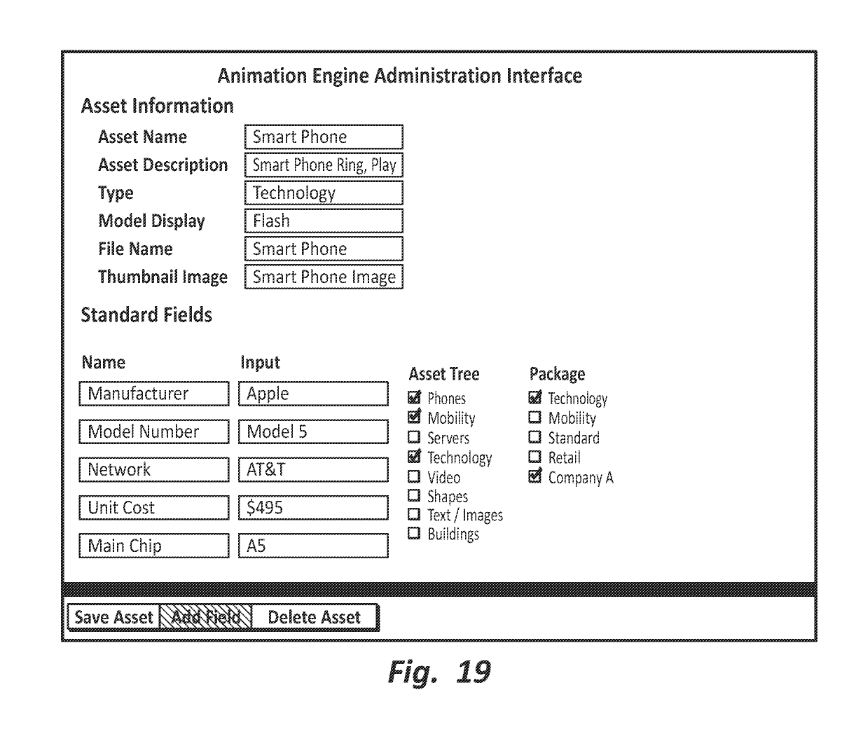

FIG. 19 is the system interface used to upload the intelligent assets used in the animation engine. Similar to creating a financial model, a specification for an intelligent asset is provided for the animation engine. External tools, e.g., Flash, are used to build the asset to the specifications. The asset is then loaded into the system via the system interface. When the asset is loaded into the system, information about the asset is provided so the user will know how to use the asset.

An external animation engine 384 is selected for use with the asset 386 to create an animation the user can manipulate 388. FIG. 19 has entries that are self explanatory and demonstrates an administrative interface that appears on the screen of the user's computer which shows how the animation engine is operated by the user. Here an example is being used in which the user wishes to illustrate the operation of a “smart phone.” The administrative entries are labeled and self-explanatory.

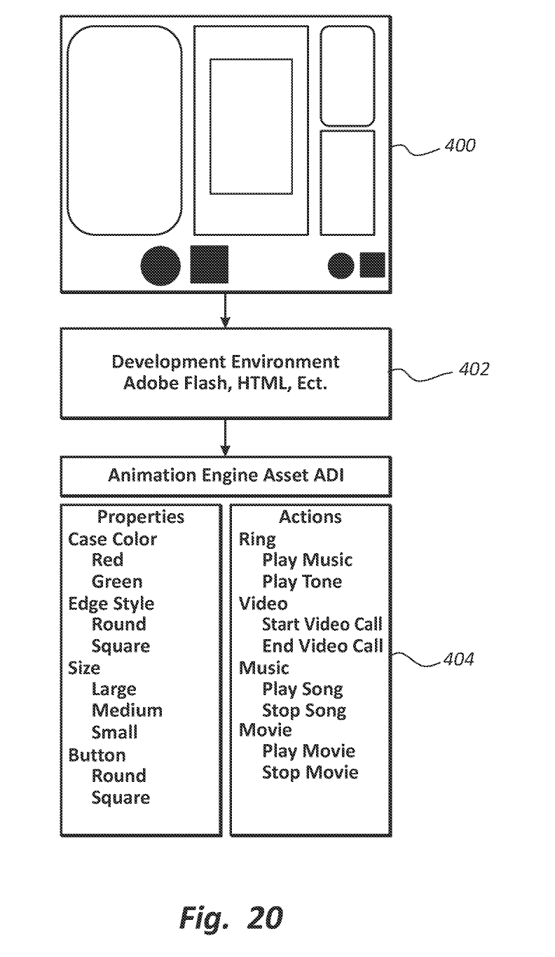

FIG. 20 is an example of specifications that are used to create the imagery (400) and to develop the underlying code in Flash 402 to create the specified functionality 404 of a smart phone intelligent asset that will be used in the animation engine. It then shows the options available to compile the asset creating a finished intelligent asset. In this case, a smart phone that can play music, make a video call, or play a movie. The finished asset is a “file”, which is loaded into the animation engine via the system interface. Users access the smart phone via the asset browser.

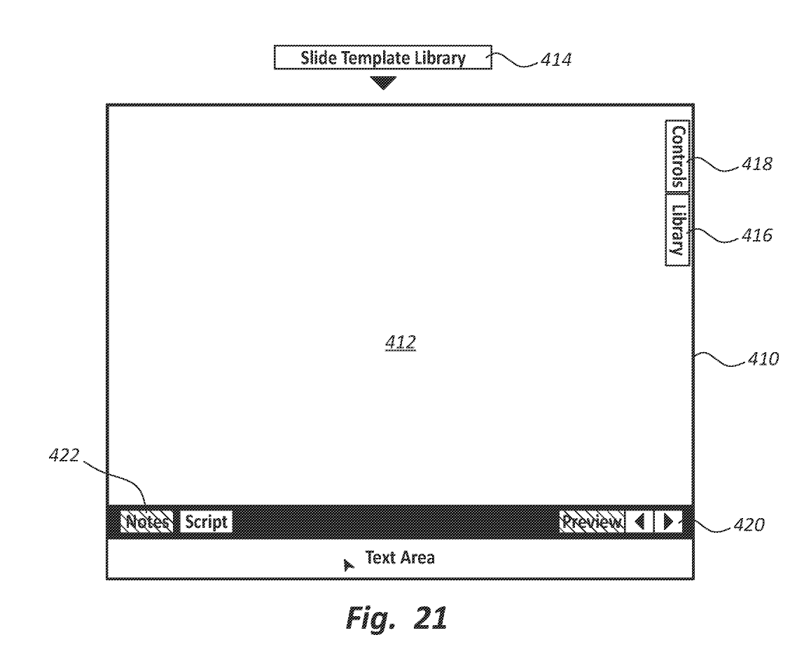

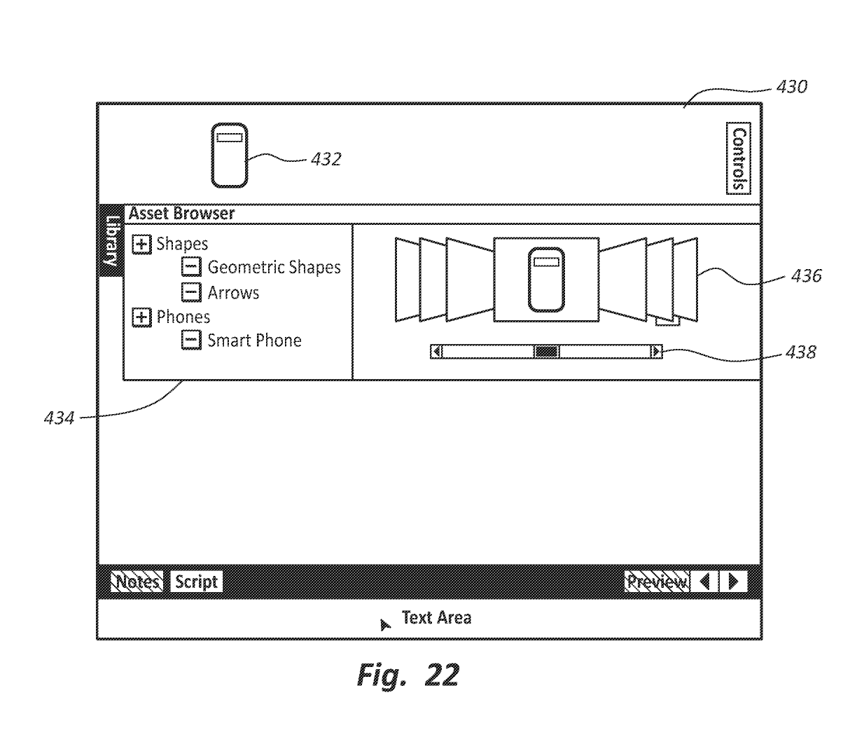

As better seen in FIG. 21, the animation engine presents the user with a screen 410 that presents the user with a canvas 412 where intelligent assets, e.g., a smart phone, can be selected from the asset library or from other libraries 416. A control panel 418 and a button bar 420 are available for the user to control the properties of an intelligent asset used in an animation. Notes and scripts 422 can be added as desired. FIG. 22 shows the screen 430 that becomes available when the user accesses the library by operating the library button 416. Here shown is an example where the user accesses an intelligent asset, a smart phone 432, which is to be animated. An asset tree 434 is provided along with a cover flow 436 which displays a thumbnail image of each asset for use in a diagram. The cover flow 436 can be quickly viewed by moving the slide 438.

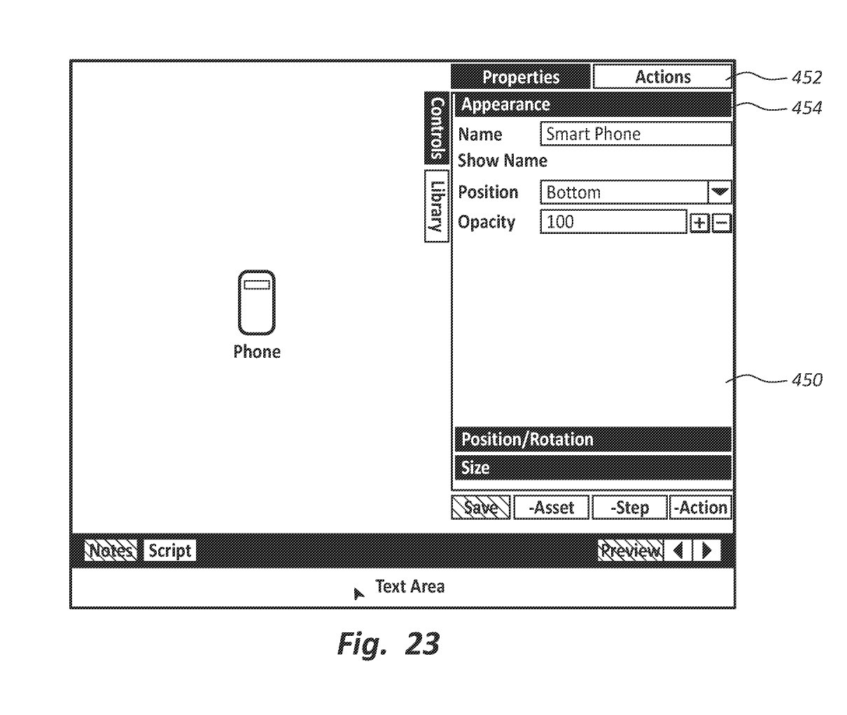

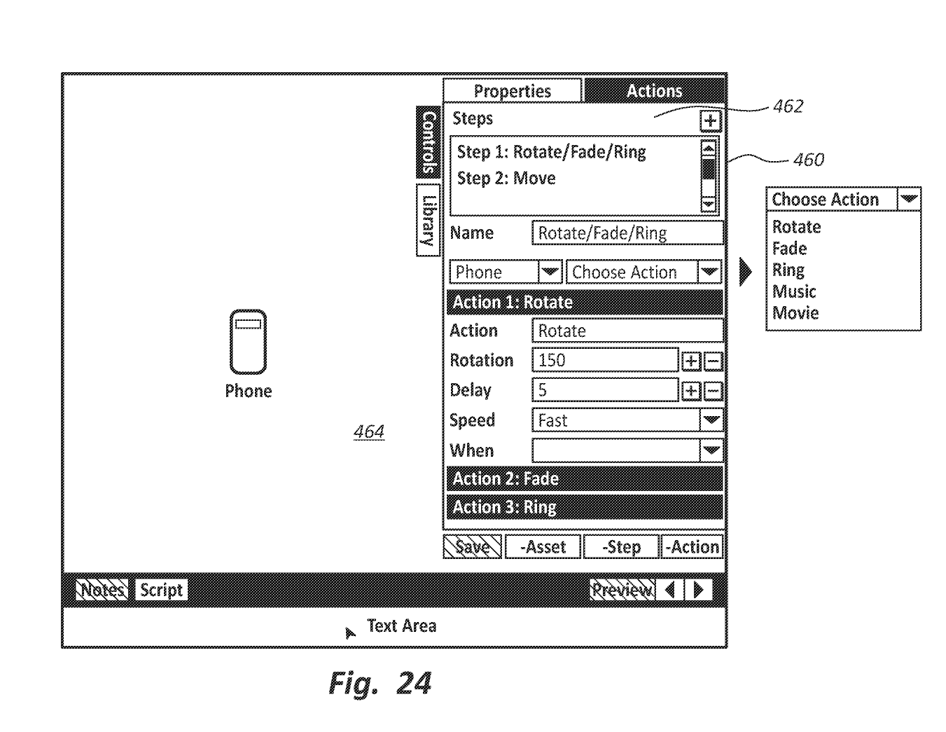

FIG. 23 shows the properties panel 350 of the animation engine as seen by a user for animating operation of a smart phone as an example as hereinbefore discussed. The panel allows the user to change the properties of the object or asset on the canvas 412 (FIG. 21). The user may create animation by selecting various actions 452 and also vary the appearance 454 in a variety of ways such as opacity. FIG. 24 is an illustration of the actions panel 460 accessed by operation of the actions button 452. Various actions 462 can be had by operation of the various buttons 462 including rotation, fade away, movement and the like. The effect of the operations are observed on the canvas showing the object or asset that is being animated. While appearing complicated, it is in reality quite easy to create animations for items in the presentation for the sale of the “big ticket” product.

Automated discovery may be undertaken to collect data and facts from the customer that relate to the “big ticket” product to be sold. A wide variety of web based tools and programs are now available to collect information about markets, industries, and customers. In addition, information may often be provided by the customer when asked to support the sales presentation.

It is presently contemplated that at least one discovery tool will be created that is used for collecting information from one or more customers, in general. The discovery tools may include interview guides, data sheets, surveys, and other tools to gather needed information to assess the process or operation into which the product will be integrated. Further, the discovery tools may be customized to a targeted customer. In addition, the collected information supports use of the financial impact models as applied to the targeted customer. Although implemented through a web based form, collection of information is supported through any information gathering and collection process, to include the use of stand-alone systems and the like.

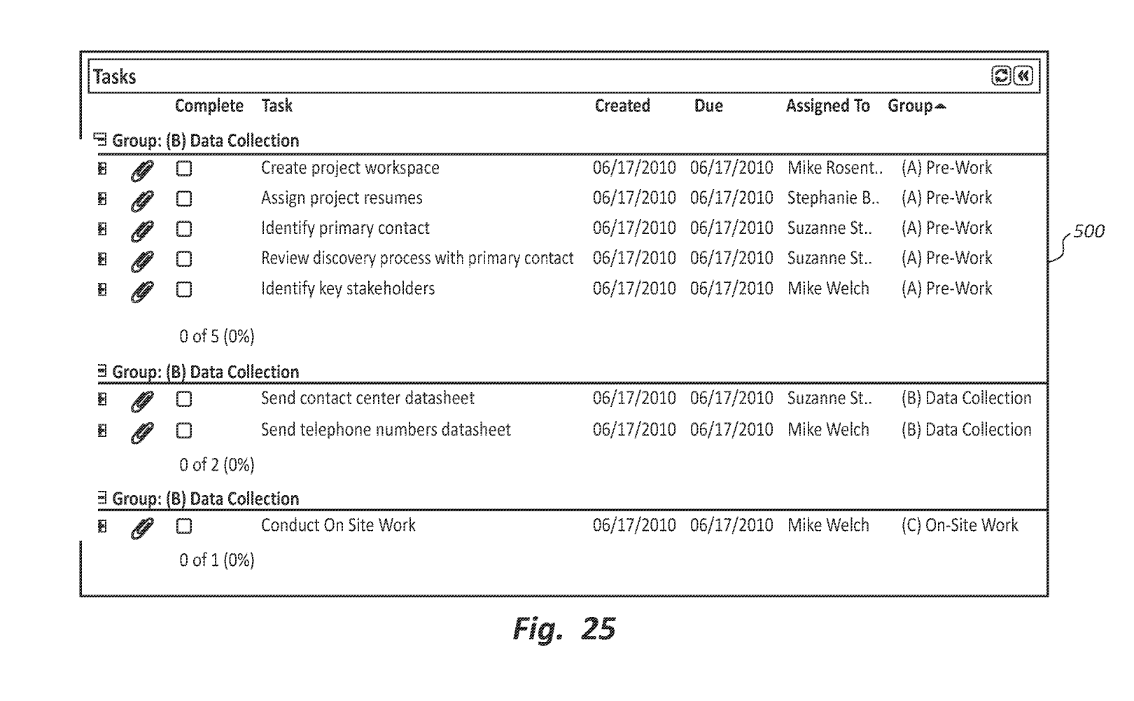

The discovery function or process also includes a task list builder, a sample of which is shown in FIG. 25. That is the user is able to draw from various task group templates for purposes of creating the list of tasks necessary to perform discovery for a particular project. FIG. 25 shows a task list 900 that a sales team used for conducting discovery. The system can include atomic groups of tasks from the task group templates that can be combined to form a task list for any discovery effort. As task groups are created, they are stored in a database and can be imported into a workspace as needed. In one embodiment, task groups are created once and reused many times for different discovery efforts. This gives the sales team the ability to quickly “snap” together a discovery task list. In addition, the task list functionality ensures that the discovery process is consistent and repeatable when used for different targeted customers all belonging to the same group of customers.

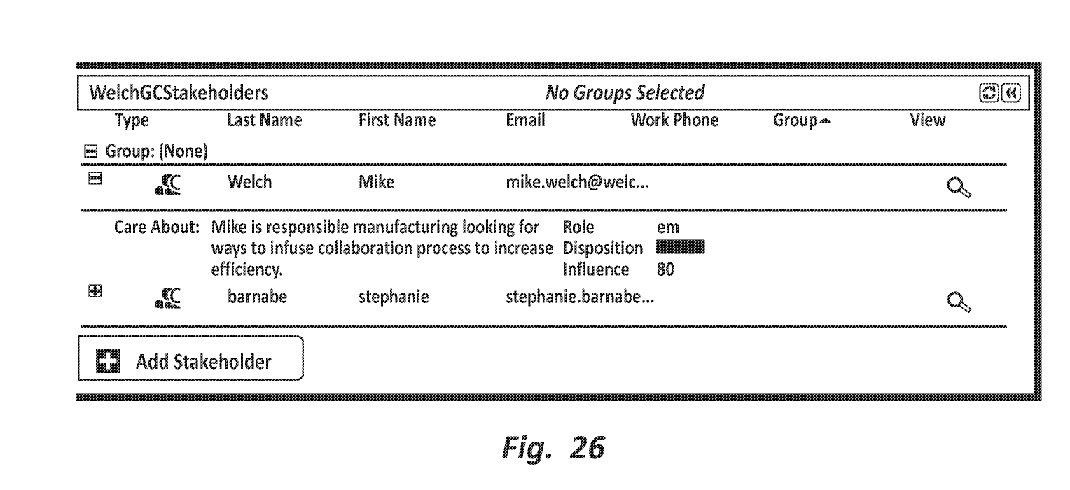

One discovery task may include steps to identify those who are stakeholders in the decision making process. FIG. 26 is an illustration of a stakeholders profile, where a stakeholder is a person in the targeted customer's business that has information the sales team needs to collect during discovery.

FIG. 26 shows a stakeholder profile, to include the following: contact information; what the stakeholder cares about; their role (e.g., IT, user, middle management, executive management, or executive sponsor); their disposition (red, green or yellow); and how much influence the stakeholder has over choosing the selling company. The stakeholder functionality allows the sales team to quickly get a sense of who the stakeholders are and their level of influence. As an example, in FIG. 26, Mike Welch is listed as a stakeholder and contact information for Mike Welch is also provided.

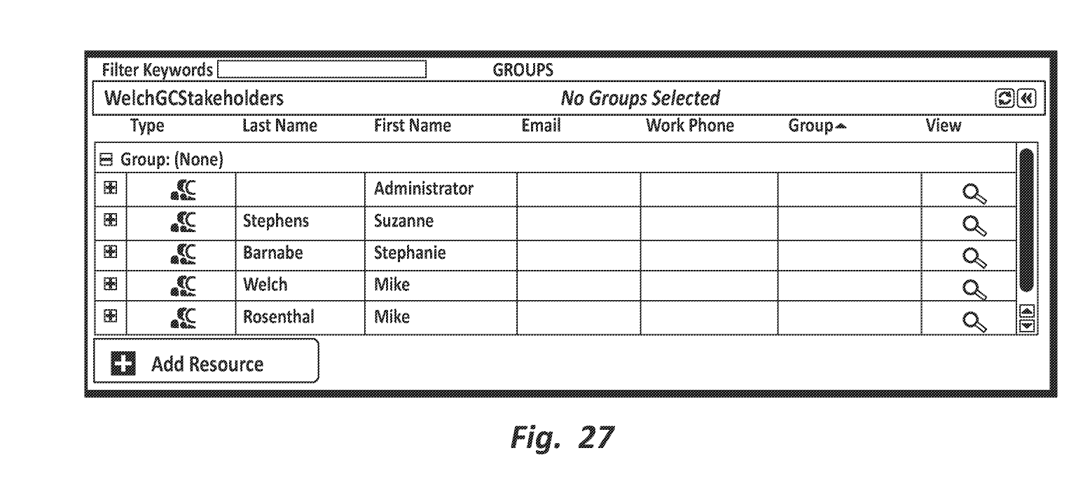

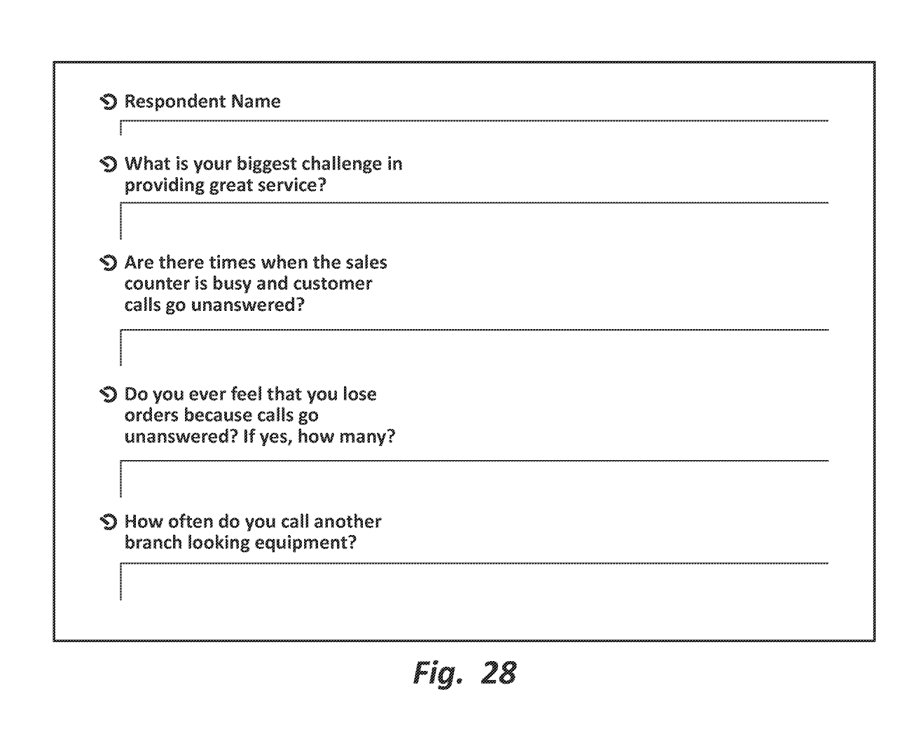

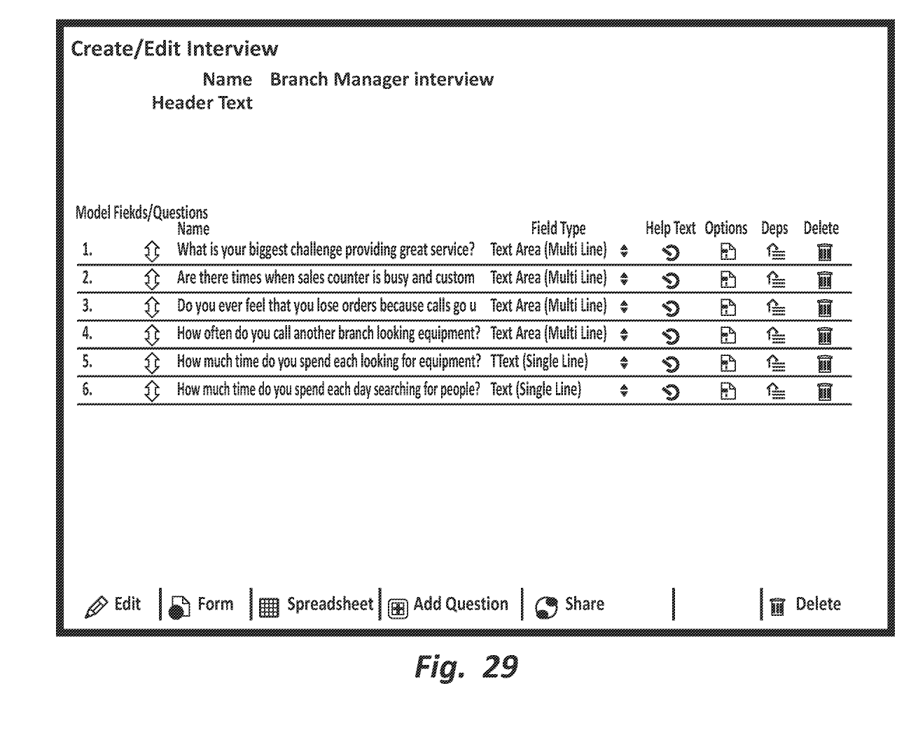

FIG. 27 is an illustration of a list of resources provided by the sales team to help with a sales execution project directed at the targeted customer. FIG. 28 is a sample interview sheet for interacting with stakeholders and others who can provide information necessary for the sales effort. FIG. 29 is an “edit interview” page that the sales team can use to customize interviews based on the role of the stakeholder.

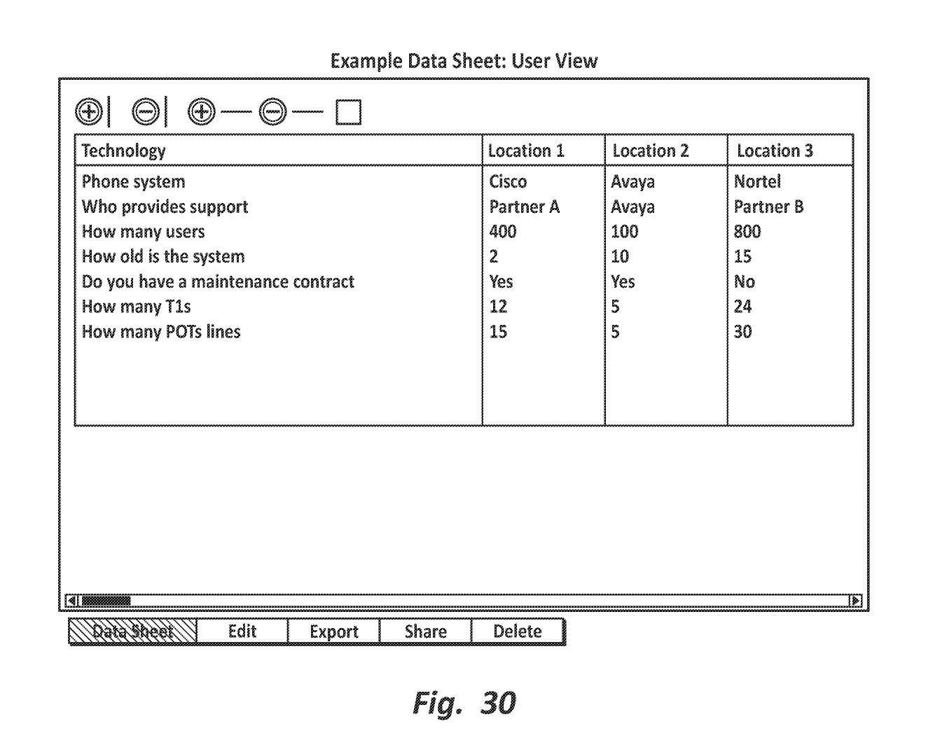

FIG. 30 is an illustration of a data sheet that is used to collect detailed information from stakeholders.

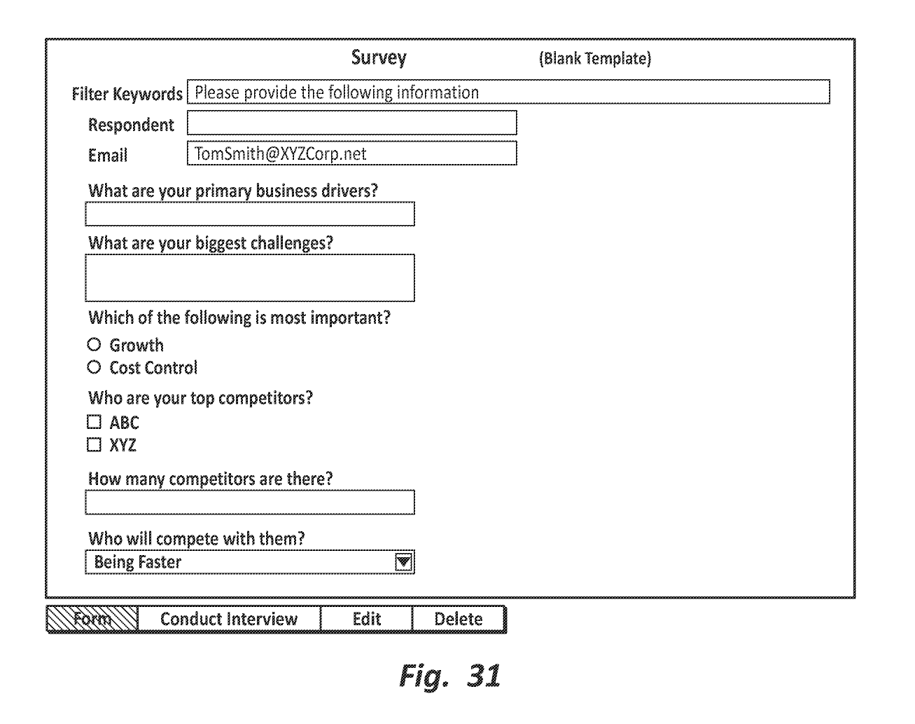

FIG. 31 is an illustration of a survey that is used to collect information from large groups of stakeholders. Data sheets and survey sheets located in a customer workspace can also be connected directly to slides in a real time presentation.

The above discussion should illustrate that the present invention is contemplated to be embodied in a system that involves “cloud” computing which is also known as Software as a Service (SaaS). So for example, the entire system being discussed may be hosted in Tier 4 datacenter. Users access the system via a Web Browser. Google Chrome is a preferred system, but the system herein disclosed will work with any modern browser. Once the cloud system is accessed, it can be seen that data is input by the user and that data is sent to the remote site where the computations are undertaken with the resulting data supplied back to the user.

In summary, the system herein disclosed delivers a systematic and programmatic approach to guided sales execution that enables a sales team to proceed more logically through the sales cycle. The approach includes building a portfolio strategy for a technology or industry; sales process development; training; and mentoring. The entire approach creates sustainable behavioral changes within the sales team to drive improved sales performance.

Accordingly, embodiments of the present invention provide for a programmatic approach to guided sales execution. Other embodiments of the invention provide the above advantage and further develops a system strategy based on business drivers and financial factors such that the benefits of the “big ticket” product or service are organized around business drivers and financial factors important to the customer and including ROI but separate from reliance on simple technological advances (it does it better/faster/cheaper). Still other embodiments of the present invention provide the above advantages and further provide for a system that facilitates collaborative collection of information related to a targeted company and building of a presentation touting the benefits of a product or service based on business drivers and financial factors to the targeted customer.

A system and method for a programmatic approach to guided sales execution is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

The approach is applicable for any type of sales that involves data collection, financial modeling, business case creation, and executive presentations.

In addition, the approach is applicable for sales directed to the offering of any product and/or service but more particularly to “big ticket” sales. For instance, the approach is applicable to the sale of any product or service in any technology or industry, such as electronics, automotive, software applications, raw materials, etc. More specifically, one programmatic approach is designed to be directed to a group of customers that all belong to the same technology or industry. As such, the overall approach is globally suited to that particular technology or industry, and furthermore can be tailored to a targeted customer within that group, such that implementation of the programmatic approach is directed to the targeted customer for purposes of sales execution.

1. A method for sales execution, comprising:
determining at least one impact area relating to the business of a customer and arising from use of a product being offered for sale to the customer;
creating at least one discovery tool used for collecting business information from and about said customer and about the impact of the use of product on said business;
creating at least one financial impact model showing a financial impact in terms of cash flow on said impact area when using and not using said product; and
creating a real time presentation showing said financial impact model when using and not using said product.

2. The method of claim 1 further including creating a workspace to store data for repeated access.

3. A method for effecting sales of a product, said method comprising:
identifying a target customer;
mapping the business drivers for the target customer to identify impact areas;
developing the financial factors for the target customer and the product; and
presenting the financial factors, the business drivers and the impact areas to the customer.

4. The method of claim 3 wherein the target customer is first qualified.

5. The method of claim 4 wherein the mapping includes closing for discovery.

6. The method of claim 4 wherein qualification of the customer includes identifying an executive of the customer to assist.

7. The method of claim 5 wherein close for discovery includes identifying impact areas and selecting the discovery process.

8. The method of claim 7 wherein discovery includes collecting data and analysis of the data.

9. The method of claim 8 wherein the discovery includes collecting data from the customer.

10. The method of claim 9 wherein presenting includes presenting data comparing the current status of the customer in comparison to the proposed state.

11. A method for effecting sales of a product, said method comprising:
identifying and qualifying a target customer;
mapping the business drivers for the target customer to identify impact areas including retention, productivity, growth, and cost control;
developing the financial factors for the target customer and the product; and
presenting the financial factors, the business drivers and the impact areas to the customer.

12. The method of claim 11 wherein a real time presentation model is provided to present the financial factors, the business drivers and the impact areas in an interactive presentation.

13. A method for effecting sales of a product, said method comprising:
identifying and qualifying a target customer and conducting discovery to collect data relating to the use of the product by the target customer;
mapping the business drivers for the target customer to identify impact areas;
developing the financial factors for the target customer and the product;
creating interactive financial models for the business drivers and the financial factors; and
creating a real time presentation to present the financial factors, the business drivers and the impact areas with and without the product.

14. A method for effecting sales of a product, said method comprising:
providing a computer system with at least one terminal having a screen visible by the user; identifying a target customer and operating said computer system to conduct discovery of and about said customer;
operating said computer to map the business drivers for the target customer;
developing the financial factors for the target customer and the product and related impact areas;
operating said computer to convert each impact area into a cash flow number;
operating said computer to create interactive financial models for the business drivers and the financial factors using the cash flow from the impact areas; and
creating a real time presentation to present the financial factors, the business drivers and the impact areas with and without the product.

15. The method of claim 13 wherein said computer system includes a model engine to convert each impact area into a cash flow number.

16. The method of claim 14 wherein said computer system includes a real time presentation engine to create and present the real time presentation.

17. The method of claim 15 wherein said computer system includes an animation engine for creating animations for use with said real time presentation.

18. A business process comprising:
identifying a product to be sold;
identifying a customer having a business;
developing the business drivers of the customer;
discovering business information about the customer;
comparing the product in use and not in use within the business of the customer;
calculate at least one a financial impact model in cash flow terms; and
visually presenting a business case to purchase the product to be sold using said financial impact model and the business information.

19. The business process of claim 18 further including a model engine configured to develop a plurality of financial impact models in cash flow terms.

20. The business process of claim 19 further including images of the product to be sold and further including a business animation model to animate said images of the product when visually presenting the business case.

21. A computer system comprising
a processor for processing information, said processor including a memory and means for communicating information to and from the memory;
at least one terminal connected to said processor and operable by the user to communicate information to and from said processor, said terminal including at least one screen to visually display information for observation by a user and one input device for inputting information for communication to said processor, said terminal being operable to communicate the definition of at least one impact area relating to the business of a customer and arising from use of a product being offered for sale to the customer, said terminal being operable to cause said processor to create at least one discovery tool used for collecting business information from and about said customer and the impact of the use of product on said business, said terminal being operable to cause said processor to create at least one first financial impact model showing a financial impact in terms of cash flow on said impact area when using and not using said product based on said business information, and said terminal being operable to cause said processor to create a real time presentation showing said first financial impact model when using and not using said product; and
a display device connected to said processor and said at least one terminal, said processor and said terminal being operable to cause said real time presentation to be displayed for observation by said customer.

22. The computer system of claim 21 wherein said first financial impact model includes a template and data, wherein said processor includes at least one workspace configured to receive and store said financial impact model, and wherein said at least one terminal is operable to connect to said processor to recover at least the template of said financial impact model and at least one workspace for a customer that includes at least the one financial impact model, and wherein said terminal is operable to access a project workspace created in said processor for a targeted customer.

23. The computer system of claim 21 wherein said processor includes a company workspace, a personal workspace and a customer work space all to store discovery information and real time presentation information and wherein said terminal is operable to access said personal workspace, said customer work space and said customer work space.

24. The computer system of claim 21 wherein said terminal is operable to cause the business information used to create the financial impact model to change to create at least one alternate business model.

25. The computer system of claim 21 wherein said real time presentation is interactive.

26. A mapping system for mapping business drivers, said mapping system comprising: reviewing a solution set;
identifying a plurality of impact areas;
identifying elements of each of the plurality of impact areas;
identifying the case specific information for a desired model; and
creating the impact area model by business driver.

27. The mapping system of claim 26 wherein the impact areas are retention, productivity, growth and cost control.

28. The model engine for building financial models, said model engine comprising; selecting a model interface to interface with data sources;
creating data inputs to receive data from the data sources;
create calculation steps for performing calculations using the data from the data sources;
testing the model calculations;
creating model inputs;
linking a model interface with the model inputs;
assign a model type and location; and
testing the functionality of the model.

29. The model engine of claim 28 further including assigning a model to a model domain and assigning the model to a model package.

30. The model engine of claim 28 wherein said model is stored in a slide library.

31. The model engine of claim 28 wherein the model is one of a real time financial model, a cash flow model and a business case model.

32. A method for creating animations of an image, said method including:
creating an intelligent asset that includes a image to be animated;
identifying asset information including standard fields, properties and actions;
assigning a location to the asset information;
selecting an animation engine;
selecting the asset information for use in the engine; and
operating the animation engine to show properties and actions of the asset.
